(19) United States
(12) Patent Application Publication
(10) Pub. No.: US 2025/0321559 A1
(43) Pub. Date: Oct. 16, 2025

(54) DENTAL ENGRAVING AND MILLING MACHINE AND CONTROL METHOD THEREOF

(71) Applicant: Zhongcong (Tianjin) Medical Technology Co., Ltd., Tianjin (CN)

(72) Inventors: Jingkai SUN, Tianjin (CN); Huiting WANG, Tianjin (CN); Yingjun QI, Tianjin (CN); Meng XUE, Tianjin (CN)

(73) Assignee: Zhongcong (Tianjin) Medical Technology Co., Ltd., Tianjin (CN)

(21) Appl. No.: 19/252,981

(22) Filed: Jun. 27, 2025

(30) Foreign Application Priority Data
Apr. 9, 2025 (CN) 202510439250.3
Apr. 9, 2025 (CN) 202510439352.5
Apr. 9, 2025 (CN) 202510439353.X
Apr. 9, 2025 (CN) 202520657818.4

(51) Int. Cl. G05B 19/18; A61C 13/00

(52) U.S. Cl. CPC G05B 19/182; A61C 13/0004; A61C 13/0006; A61C 13/0022; G05B 2219/45145; G05B 2219/45167

(57) ABSTRACT

A dental engraving and milling machine includes a housing, a controller, an X-axis moving assembly, a Z-axis moving assembly, a Y-axis moving assembly, a first A-axis moving assembly, a second A-axis moving assembly, and a B-axis moving assembly. When a dental prosthesis blank needs to be processed, the B-axis moving assembly is driven by the X-axis moving assembly to move, and the first A-axis moving assembly and the second A-axis moving assembly are driven to reach a required height. The Z-axis moving assembly is driven by the Y-axis moving assembly to move in a Y-axis direction. Before the Z-axis moving assembly is made to reach a first dental prosthesis fixture or a second dental prosthesis fixture, a cutting spindle is driven by the Z-axis moving assembly to move in a Z-axis direction, thereby processing the dental prosthesis blank through a tool on the cutting spindle.

### CROSS-REFERENCE TO RELATED APPLICATIONS

This application claims priorities to Chinese Patent Application No. 202510439353.X with a filing date of Apr. 9, 2025, Chinese Patent Application No. 202510439250.3 with a filing date of Apr. 9, 2025, Chinese Patent Application No. 202510439352.5 with a filing date of Apr. 9, 2025, and Chinese Patent Application No. 202520657818.4 with a filing date of Apr. 9, 2025. The content of the aforementioned applications, including any intervening amendments thereto, is incorporated herein by reference.

### TECHNICAL FIELD

The present disclosure relates to the field of dental engraving machines, and in particular, relates to a dental engraving and milling machine and a control method thereof.

### BACKGROUND

Currently, in the conventional technology, dental prosthetic materials are classified into metal-based, ceramic-based, and resin-based types, and different cutting environments are needed for processing the different materials. For example, a cutting fluid needs to be sprayed for metal processing to achieve tool cooling during numerical control machining, ensuring quality of a cut surface. However, the ceramic-based and resin-based dental prosthetic materials cannot be cooled by using the cutting fluid. Therefore, at least two/two types of integrated dental engraving and milling machines are required for dental processing (in a dry cutting environment and a wet cutting environment), to meet processing requirements of most prostheses. In this case, a processing facility needs to be equipped with redundant equipment, supporting circuits, compressed air pipelines, dedicated workspaces, etc. Unbalanced utilization of the redundant equipment leads to waste of equipment and investment, excessive occupation of space, high time costs for equipment operation training, and the like.

### SUMMARY OF PRESENT INVENTION

The present disclosure aims to solve at least one of the technical problems existing in existing or related technologies.

In view of this, a first aspect of the present disclosure provides a dental engraving and milling machine, including: a housing, where a cavity is disposed in the housing; a controller, where the controller is located in the cavity, and the controller is connected to the housing; an X-axis moving assembly, where the X-axis moving assembly is electrically connected to the controller, and the X-axis moving assembly is located in the cavity; a Z-axis moving assembly, where the Z-axis moving assembly is electrically connected to the controller, and the Z-axis moving assembly is located in the cavity; a cutting spindle, where the cutting spindle is connected to an output end of the Z-axis moving assembly, a tool is disposed on the cutting spindle, and the tool is configured to engrave a dental prosthesis blank; a Y-axis moving assembly, where the Y-axis moving assembly is electrically connected to the controller, an output end of the Y-axis moving assembly is connected to the Z-axis moving assembly, the Y-axis moving assembly is located in the cavity, and the Y-axis moving assembly is movable in a third direction; a first A-axis moving assembly, where the first A-axis moving assembly is electrically connected to the controller, a first dental prosthesis fixture is disposed at an output end of the first A-axis moving assembly, and the first A-axis moving assembly cooperates with the cutting spindle to perform dry cutting on the dental prosthesis blank; a second A-axis moving assembly, where the second A-axis moving assembly is electrically connected to the controller, a second dental prosthesis fixture is disposed at an output end of the second A-axis moving assembly, and the second A-axis moving assembly cooperates with the cutting spindle to perform wet cutting on the dental prosthesis blank; and a B-axis moving assembly, where a first end of the B-axis moving assembly is connected to the first A-axis moving assembly, a second end of the B-axis moving assembly is connected to the second A-axis moving assembly, the B-axis moving assembly is connected to the X-axis moving assembly, and the B-axis moving assembly is configured to drive the first A-axis moving assembly and the second A-axis moving assembly to rotate, where in an initial state, the X-axis moving assembly is configured to drive the B-axis moving assembly to move in an X-axis direction, the Y-axis moving assembly is configured to drive the Z-axis moving assembly to move in a Y-axis direction, the Z-axis moving assembly is configured to drive the cutting spindle to move in a Z-axis direction, and the first A-axis moving assembly and the second A-axis moving assembly are configured to rotate around the X-axis direction.

In addition, the dental engraving and milling machine in the above technical solution provided by the present disclosure also has the following additional technical features:

In some technical solutions of the present disclosure, optionally, the dental engraving and milling machine further includes a first protective enclosure, where a first accommodating space is provided in the first protective enclosure, the first protective enclosure is connected to the first A-axis moving assembly, and the first A-axis moving assembly is located in the first accommodating space; and a second protective enclosure, where a second accommodating space is provided in the second protective enclosure, the second protective enclosure is connected to the second A-axis moving assembly, and the second A-axis moving assembly is located in the second accommodating space, where a side that is of the first protective enclosure and that is close to the first end of the B-axis moving assembly is provided with a first slot, the first A-axis moving assembly passes through the first slot and is connected to the first end of the B-axis moving assembly, a side that is of the second protective enclosure and that is close to the second end of the B-axis moving assembly is provided with a second slot, and the second A-axis moving assembly passes through the second slot and is connected to the second end of the B-axis moving assembly.

In some technical solutions of the present disclosure, optionally, the dental engraving and milling machine further includes a dry cutting dust collector, where the dry cutting dust collector is connected to the housing, the dry cutting dust collector is located in the cavity, and the dry cutting dust collector is electrically connected to the controller, where a first notch is provided on the first protective enclosure, the first protective enclosure is connected to the dry cutting dust collector at the first notch through first tubing, and the dry cutting dust collector is configured to adsorb dust generated during dental prosthesis processing.

In some technical solutions of the present disclosure, optionally, the dental engraving and milling machine further includes a cutting fluid circulation module, where the cutting fluid circulation module is connected to the housing, the cutting fluid circulation module is located in the cavity, and the cutting fluid circulation module is electrically connected to the controller, where a second notch is provided on the second protective enclosure, the second protective enclosure is connected to the cutting fluid circulation module at the second notch through second tubing, the cutting fluid circulation module is configured to circulate a cutting fluid, a water pump is disposed on the Z-axis moving assembly, an input end of the water pump is connected to the cutting fluid circulation module, and an output end of the water pump is capable of spraying water toward the tool.

In some technical solutions of the present disclosure, optionally, the first dental prosthesis fixture includes an arched block, where the arched block is fixedly connected to a fixture clamping slot provided at the output end of the first A-axis moving assembly, an end that is of the arched block and that is away from the clamping slot is provided with a locating slot, and the locating slot is fixedly connected to the dental prosthesis blank.

In some technical solutions of the present disclosure, optionally, the dental engraving and milling machine further includes a calibration jig and a photoelectric sensor, where the calibration jig includes a calibration ring, the calibration ring is detachably mounted on the first dental prosthesis fixture, a measurement through hole is provided on a center position of the calibration ring, a bottom of the measurement through hole is fixedly connected to a calibration surface, and

the photoelectric sensor is detachably connected to the cutting spindle, and the cutting spindle drives the photoelectric sensor to move, and the photoelectric sensor is configured to perform zero-point calibration on a motion axis of the dental engraving and milling machine by detecting the calibration ring and the calibration surface.

In some technical solutions of the present disclosure, optionally, the X-axis moving assembly includes a first base plate and an X-axis servo motor, where the first base plate is connected to the X-axis servo motor, the X-axis servo motor is located on a first side of the first base plate, a temperature sensor is connected to the first base plate, the temperature sensor is located on a second side that is of the first base plate and that is away from the X-axis servo motor, actuating elements are further connected to the first base plate, and the actuating elements are respectively located on a third side and a fourth side of the first base plate;
the Y-axis moving assembly includes a second base plate and a Y-axis servo motor, where the second base plate is connected to the Y-axis servo motor, a temperature sensor is connected to the second base plate, the temperature sensor is located on a side of the second base plate, an actuating element is also connected to the second base plate, and the actuating element is located on a surface that is of the second base plate and that is away from the Y-axis servo motor; and
the dental engraving and milling machine further includes a frequency converter, where the frequency converter is located in the cavity, and the frequency converter is electrically connected to the controller.

A second aspect of the present disclosure provides a calibration method of a dental engraving and milling machine, where the calibration method is used for the above dental engraving and milling machine, and includes the following steps: S1, obtaining an X-axis zero point of an X-axis horizontally moving on a first plane and a Y-axis zero point of a Y-axis longitudinally moving on the first plane; S2, determining a Z-axis zero point of a Z-axis moving in a direction perpendicular to the first plane, an A-axis zero point of an A-axis rotating around the X-axis, and a B-axis zero point of a B-axis rotating around the Y-axis according to the X-axis zero point and the Y-axis zero point; and S3, obtaining a zero point of the motion axis of the dental engraving and milling machine according to the X-axis zero point, the Y-axis zero point, the A-axis zero point, and the B-axis zero point, to complete zero-point calibration of the motion axis of the dental engraving and milling machine.

In some technical solutions of the present disclosure, optionally, in S1, the obtaining an X-axis zero point includes: controlling the cutting spindle to move a sensing end head of the photoelectric sensor into the measurement through hole, and making the sensing end head of the photoelectric sensor be located above the calibration surface; controlling the photoelectric sensor to move forward along an X-axis until an edge of the measurement through hole is detected by the sensing end head of the photoelectric sensor, stopping the X-axis, and recording a first X-axis measurement value x₁ when the photoelectric sensor moves forward along the X-axis; controlling the photoelectric sensor to move reversely along the X-axis until the edge of the measurement through hole is detected by the sensing end head of the photoelectric sensor, stopping the X-axis, and recording a second X-axis measurement value x₂ when the photoelectric sensor moves reversely along the X-axis; and obtaining a position parameter x₀ of the X-axis zero point according to the first X-axis measurement value x₁ and the second X-axis measurement value x₂, where a calculation formula of the position parameter x₀ of the X-axis zero point is as follows: x₀=x₁+x₂/2; thereby obtaining coordinates (x₀,0) of the X-axis zero point; and

the obtaining a Y-axis zero point includes: controlling the cutting spindle to move the sensing end head of the photoelectric sensor into the measurement through hole, and making the sensing end head of the photoelectric sensor be located above the calibration surface; controlling the photoelectric sensor to move forward along a Y axis until the edge of the measurement through hole is detected by the sensing end head of the photoelectric sensor, stopping the Y-axis, recording a first Y-axis measurement value y₁ when the photoelectric sensor moves forward along the Y-axis; controlling the photoelectric sensor to move reversely along the Y axis until the edge of the measurement through hole is detected by the sensing end head of the photoelectric sensor, stopping the Y-axis, and recording a second Y-axis measurement value y₂ when the photoelectric sensor moves reversely along the Y-axis; and obtaining a position parameter y₀ of the Y-axis zero point according to the first Y-axis measurement value y₁ and the second Y-axis measurement value y₂, where a calculation formula of the position parameter y₀ of the Y-axis zero point is as follows: y₀=y₁+y₂/2; thereby obtaining coordinates (0, y₀) of the Y-axis zero point.

In some technical solutions of the present disclosure, optionally, in S2, the obtaining a Z-axis zero point includes: determining origin coordinates (x₀, y₀) of a first plane according to the X-axis zero point and the Y-axis zero point; and controlling the photoelectric sensor to be located at a coordinate origin position of the first plane, moving the photoelectric sensor along a Z-axis until a sensing end head of the photoelectric sensor is in contact with the calibration surface, stopping the Z-axis, and obtaining coordinates (x₀,y₀, z₀) of the Z-axis zero point, where a contact position is a position z₀ of the Z-axis zero point.

In some technical solutions of the present disclosure, optionally, in S2, the obtaining an A-axis zero point includes: determining origin coordinates (x₀,y₀) of a first plane according to the X-axis zero point and the Y-axis zero point; controlling a sensing end head of the photoelectric sensor to be located at a coordinate origin position of the first plane; after controlling the sensing end head of the photoelectric sensor to move for a first distance along a Z-axis in a direction away from the calibration jig, controlling the photoelectric sensor to move forward for a second distance along a Y-axis, to make the sensing end head of the photoelectric sensor be located on an upper surface of the calibration ring; controlling the sensing end head of the photoelectric sensor to move along the Z-axis in a direction close to the calibration jig to make the sensing end head of the photoelectric sensor be in contact with the upper surface of the calibration ring, stopping the Z-axis, and recording a first A-axis measurement value A₁; controlling the sensing end head of the photoelectric sensor to return to the coordinate origin position of the first plane; after controlling the sensing end head of the photoelectric sensor to move for the first distance along the Z-axis in the direction away from the calibration jig, controlling the photoelectric sensor to move reversely for the second distance along the Y-axis, to make the sensing end head of the photoelectric sensor be located on the upper surface of the calibration ring; controlling the sensing end head of the photoelectric sensor to move along the Z-axis in the direction close to the calibration jig to make the sensing end head of the photoelectric sensor be in contact with the upper surface of the calibration ring, stopping the Z-axis, and recording a second A-axis measurement value A₂; and obtaining a position parameter A_0 of the A-axis zero point according to the first A-axis measurement value A₁ and the second A-axis measurement value A₂, where a calculation formula of the position parameter A₀ of the A-axis zero point is as follows:

$${A}_{0} = \frac{{A}_{1} - {A}_{2}}{2} .$$

In some technical solutions of the present disclosure, optionally, the calibration method of the dental engraving and milling machine further includes calibration of the A-axis zero point, where the calibration of the A-axis zero point includes: when A₀ is positive, after controlling the sensing end head of the photoelectric sensor to return to the coordinate origin position of the first plane, controlling the sensing end head of the photoelectric sensor to move for the first distance along the Z-axis in the direction away from the calibration jig, and then controlling the photoelectric sensor to move forward for the second distance along the Y-axis, to make the sensing end head of the photoelectric sensor be located on the upper surface of the calibration ring; and after controlling the sensing end head of the photoelectric sensor to move along the Z-axis for a distance of A₁−A₀ in the direction close to the calibration jig, stopping the Z-axis, controlling the calibration jig to rotate around an X-axis until the sensing end head of the photoelectric sensor is controlled to be in contact with the upper surface of the calibration ring, thereby completing the calibration of the A-axis zero point; or when A₀ is negative, after controlling the sensing end head of the photoelectric sensor to return to the coordinate origin position of the first plane, controlling the sensing end head of the photoelectric sensor to move for the first distance along the Z-axis in the direction away from the calibration jig, and then controlling the photoelectric sensor to move reversely for the second distance along the Y-axis, to make the sensing end head of the photoelectric sensor be located on the upper surface of the calibration ring; and after controlling the sensing end head of the photoelectric sensor to move along the Z-axis for a distance of A₂−A₀ in the direction close to the calibration jig, stopping the Z-axis, controlling the calibration jig to rotate around an X-axis until the sensing end head of the photoelectric sensor is controlled to be in contact with the upper surface of the calibration ring, thereby completing the calibration of the A-axis zero point.

A third aspect of the present disclosure provides a control method of a dental engraving and milling machine, where the control method is used for the above dental engraving and milling machine, and includes the following steps: performing initialization on the controller, and obtaining, by the controller, a temperature parameter, a first status code of the frequency converter, a second status code of a servo driver group, and status information of a numerical control (NC) task; determining whether to perform a first protective action based on the temperature parameter; determining whether to perform a second protective action based on the first status code; determining whether to perform a third protective action based on the second status code; and determining whether to perform a fourth protective action based on the status information of the NC task.

In some technical solutions of the present disclosure, optionally, the determining whether to perform a first protective action based on the temperature parameter includes: determining whether the temperature parameter is within a preset temperature range, and determining that a temperature is normal if the temperature parameter is within the preset temperature range; and performing, by an actuating element, the first protective action if the temperature parameter is not within the preset temperature range, where the preset temperature range is from 28° C. to 50° C.

In some technical solutions of the present disclosure, optionally, the determining whether to perform a second protective action based on the first status code includes: determining whether the first status code is zero, determining that a device status is abnormal if the first status code is zero, obtaining a first error code, sequentially analyzing correlations between the first error code and a voltage, a load current, as well as a short-circuit fault, obtaining a first abnormal element, and performing the second protective action based on the first abnormal element; and determining that the device status is normal if the first status code is not zero.

In some technical solutions of the present disclosure, optionally, the determining whether to perform a third protective action based on the second status code includes: sequentially determining whether second status codes of all servo drivers in the servo driver group are zero, determining that the device status is abnormal if the second status code of any servo driver is zero, obtaining a second error code, sequentially analyzing correlations between the second error code and a voltage, a load current, as well as a short-circuit fault, obtaining a second abnormal element, and performing the third protective action based on the second abnormal element; and determining that the device status is normal if the second status codes of all servo drivers are not zero.

In some technical solutions of the present disclosure, optionally, the determining whether to perform a fourth protective action based on the status information of the NC task includes: sequentially analyzing correlations between the status information of the NC task and startup, pause, completion, as well as exception interrupt to obtain a status text of the NC task; obtaining a protective instruction based on the status text; and performing the fourth protective action based on the protective instruction.

In addition, the control method of the dental engraving and milling machine in the above technical solution provided by the present disclosure also has the following additional technical features:

In some technical solutions of the present disclosure, optionally, the control method of the dental engraving and milling machine further includes performing initialization on a device, creating, by the controller, an instruction file, and receiving, by the device, the instruction file; selecting, by the device, a working mode based on the instruction file, where the working mode includes a dry-cutting mode and a wet-cutting mode; and processing, by the first A-axis moving assembly that cooperates with the cutting spindle, a dental prosthesis blank if the working mode is the dry-cutting mode; or processing, by the second A-axis moving assembly that cooperates with the cutting spindle, a dental prosthesis blank if the working mode is the wet-cutting mode.

In some technical solutions of the present disclosure, optionally, the creating, by the controller, an instruction file includes: selecting a serial number of the dental engraving and milling machine and a fixture; selecting a dental bank based on a material characteristic and a scaling ratio; determining three-dimensional data of a to-be-required dental prosthesis based on a requirement of the to-be-required dental prosthesis; determining the working mode based on the dental prosthesis blank; determining a selection instruction of the protective enclosure, a water pump working instruction and a dust collection working instruction based on the working mode; and determining a rotation speed of the cutting spindle based on the three-dimensional data of the to-be-required dental prosthesis.

In some technical solutions of the present disclosure, optionally, the processing, by the first A-axis moving assembly that cooperates with the cutting spindle, a dental prosthesis blank if the working mode is the dry-cutting mode includes: setting a first movement range of the output end of the Y-axis moving assembly; controlling the cutting spindle to rotate based on the rotation speed of the cutting spindle, controlling on and off of the dry cutting dust collector based on the dust collection working instruction; and adjusting an operation power of the dry cutting dust collector according to machining allowance; and processing the dental prosthesis blank based on the three-dimensional data of the to-be-required dental prosthesis.

In some technical solutions of the present disclosure, optionally, the adjusting an operation power of the dry cutting dust collector according to machining allowance includes: setting the dry cutting dust collector to operate at a first power if the machining allowance is first machining allowance; setting the dry cutting dust collector to operate at a second power if the machining allowance is second machining allowance; and setting the dry cutting dust collector to operate at a third power if the machining allowance is third machining allowance, where the first power is greater than the second power that is greater than the third power, and the first machining allowance is greater than the second machining allowance that is greater than the third machining allowance.

In some technical solutions of the present disclosure, optionally, the processing, by the second A-axis moving assembly that cooperates with the cutting spindle, a dental prosthesis blank if the working mode is the wet-cutting mode includes: setting a second movement range of the output end of the Y-axis moving assembly; controlling the cutting spindle to rotate based on the rotation speed of the cutting spindle; controlling on and off of the water pump based on the water pump working instruction; and processing the dental prosthesis blank based on the three-dimensional data of the to-be-required dental prosthesis.

Additional aspects and advantages of the present disclosure will be partially presented in the following description, some of which will become apparent from the following description, or learned through practice of the present disclosure.

### BRIEF DESCRIPTION OF THE DRAWINGS

The above and/or additional aspects and advantages of the present disclosure will become apparent and easy to understand from the description of the examples in conjunction with the following drawings.

FIG. 1 is a first schematic diagram of interior of a dental engraving and milling machine according to an embodiment of the present disclosure;

FIG. 2 is a second schematic diagram of interior of a dental engraving and milling machine according to an embodiment of the present disclosure;

FIG. 3 is a main view of interior of a dental engraving and milling machine according to an embodiment of the present disclosure;

FIG. 4 is a side view of interior of a dental engraving and milling machine according to an embodiment of the present disclosure;

FIG. 5 is a third schematic diagram of interior of a dental engraving and milling machine according to an embodiment of the present disclosure;

FIG. 6 is a fourth schematic diagram of interior of a dental engraving and milling machine according to an embodiment of the present disclosure;

FIG. 7 is a schematic flowchart of a control method of a dental engraving and milling machine according to an embodiment of the present disclosure;

FIG. 8 is a schematic flowchart of a control method of a dental engraving and milling machine according to an embodiment of the present disclosure;

FIG. 9 is a schematic structural diagram of a dental engraving and milling machine according to the present disclosure;

FIG. 10 is a schematic structural diagram of a first calibration jig according to the present disclosure;

FIG. 11 is a schematic structural diagram of a second calibration jig according to the present disclosure;

FIG. 12 is a schematic flowchart of a calibration method of a dental engraving and milling machine according to the present disclosure;

FIG. 13 is a schematic flowchart of a principle of determining an X-axis zero point and a Y-axis zero point in a calibration method of a dental engraving and milling machine according to the present disclosure;

FIG. 14 is a schematic flowchart of a principle of calibrating an A-axis zero point in a calibration method of a dental engraving and milling machine according to the present disclosure;

FIG. 15 is a schematic flowchart of measuring a first A-axis measurement value through contact between a photoelectric sensor and a calibration ring according to the present disclosure;

FIG. 16 is a schematic flowchart of measuring a second A-axis measurement value through contact between a photoelectric sensor and a calibration ring according to the present disclosure;

FIG. 17 is a schematic structural diagram of a first dental prosthesis fixture according to the present disclosure;

FIG. 18 is a schematic diagram of use of a first dental prosthesis fixture according to the present disclosure; and

FIG. 19 is an exploded view of use of a first dental prosthesis fixture according to the present disclosure.

Correspondences between reference numerals and part names are as follows:

10, controller; 20, X-axis moving assembly; 30, Z-axis moving assembly; 40, Y-axis moving assembly; 50, first A-axis moving assembly; 60, second A-axis moving assembly; 70, B-axis moving assembly; 80, dry cutting dust collector; 90, cutting fluid circulation module; 100, temperature sensor; 110, actuating element; 202, first base plate; 204, X-axis servo motor; 402, second base plate; 120, calibration jig; 1201, calibration ring; 1202, measurement through hole; 1203, calibration surface; 130, photoelectric sensor; 1301, sensing end head; 140, first fixture; 150, cutting spindle; 160, arched block; 1601, arc-shaped end; 1602, straight end; 16011, angular locating block; 16012: weight-reducing groove; 1603, weight-reducing hole; 170, locating slot; 180, arched processing material; 1801, connection bump; 190, second fixture; and 1901, clamping slot.

### DETAILED DESCRIPTION OF THE EMBODIMENTS

To make the objectives, features and advantages of the present disclosure more comprehensible, the present disclosure is further described in detail below with reference to the drawings and specific embodiments. It should be noted that the embodiments of the present application and the features of the embodiments can be combined with one another to derive new embodiments without conflict.

In the following description, a plurality of specific details are set forth in order to facilitate full understanding of the present disclosure, but the present disclosure can also be implemented in other ways other than those described herein. Therefore, the protective range of the present disclosure is not limited by the specific examples disclosed below.

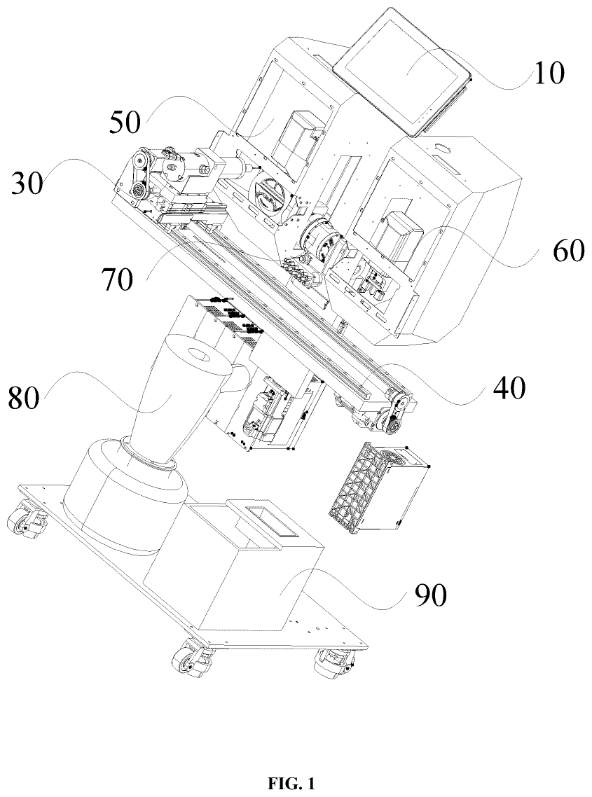

With reference to FIG. 1 to FIG. 19, the following provides descriptions of a dental engraving and milling machine and a control method thereof according to some embodiments of the present disclosure.

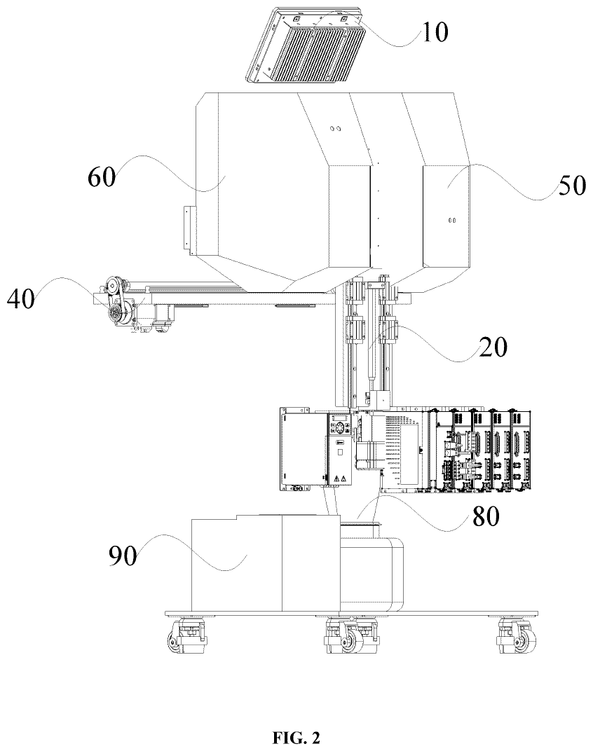

As shown in FIG. 1 and FIG. 2, according to a first aspect of the present disclosure, an integrated dental engraving and milling machine is provided, including a housing, a controller 10, an X-axis moving assembly 20, a Z-axis moving assembly 30, a cutting spindle, a Y-axis moving assembly 40, a first A-axis moving assembly 50, a second A-axis moving assembly 60, and a B-axis moving assembly 70. A cavity is disposed in the housing. The controller 10 is located in the cavity and the controller 10 is connected to the housing. The X-axis moving assembly 20 is electrically connected to the controller 10, and the X-axis moving assembly 20 is located in the cavity. The Z-axis moving assembly 30 is electrically connected to the controller 10, and the Z-axis moving assembly 30 is located in the cavity. The cutting spindle is connected to an output end of the Z-axis moving assembly 30, a tool is disposed on the cutting spindle, and the tool is configured to engrave a dental prosthesis blank. The Y-axis moving assembly 40 is electrically connected to the controller 10, an output end of the Y-axis moving assembly 40 is connected to the Z-axis moving assembly 30, the Y-axis moving assembly 40 is located in the cavity, and the Y-axis moving assembly 40 is movable in a third direction. The first A-axis moving assembly 50 is electrically connected to the controller 10, a first dental prosthesis fixture is disposed at an output end of the first A-axis moving assembly 50, and the first A-axis moving assembly 50 cooperates with the cutting spindle to perform dry cutting on the dental prosthesis blank. The second A-axis moving assembly 60 is electrically connected to the controller 10, a second dental prosthesis fixture is disposed at an output end of the second A-axis moving assembly 60, and the second A-axis moving assembly 60 cooperates with the cutting spindle to perform wet cutting on the dental prosthesis blank. A first end of the B-axis moving assembly 70 is connected to the first A-axis moving assembly 50, a second end of the B-axis moving assembly 70 is connected to the second A-axis moving assembly 60, the B-axis moving assembly 70 is connected to the X-axis moving assembly 20, and the B-axis moving assembly 70 is configured to drive the first A-axis moving assembly 50 and the second A-axis moving assembly 60 to rotate. In an initial state, the X-axis moving assembly 20 is configured to drive the B-axis moving assembly 70 to move in an X-axis direction, the Y-axis moving assembly 40 is configured to drive the Z-axis moving assembly 30 to move in a Y-axis direction, the Z-axis moving assembly 30 is configured to drive the cutting spindle to move in a Z-axis direction, and the first A-axis moving assembly 50 and the second A-axis moving assembly 60 are configured to rotate around the X-axis direction.

According to the first aspect of the present disclosure, the integrated dental engraving and milling machine is provided, including the housing, the controller 10, the X-axis moving assembly 20, the Z-axis moving assembly 30, the Y-axis moving assembly 40, the first A-axis moving assembly 50, the second A-axis moving assembly 60, and the B-axis moving assembly 70.

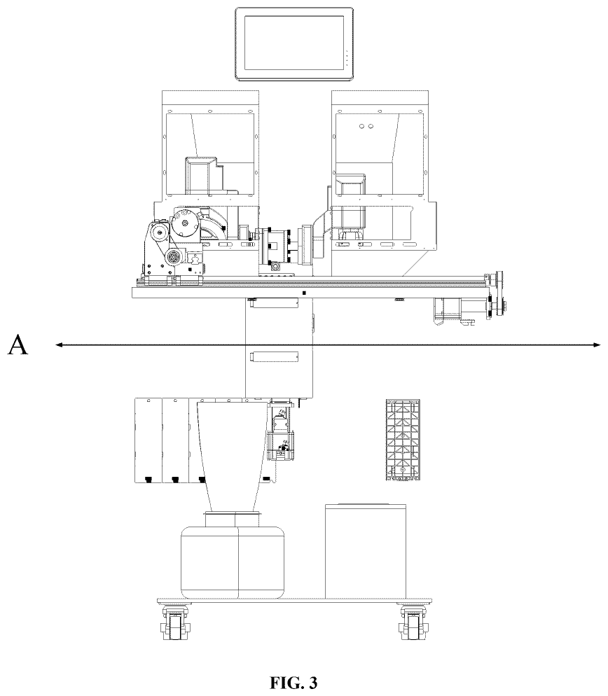

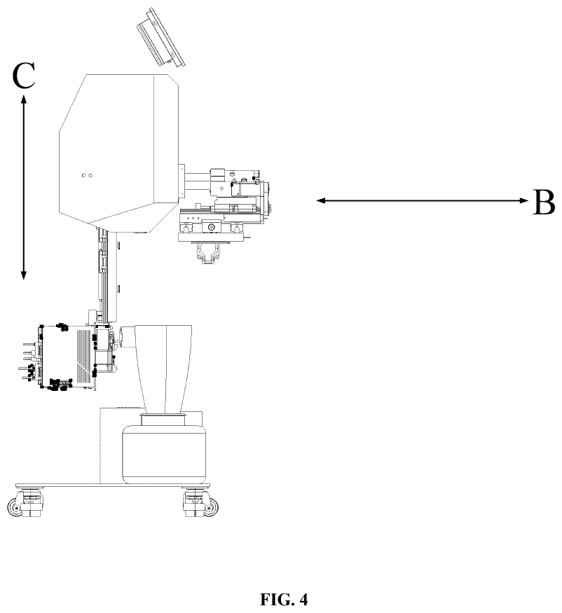

As shown in FIG. 3 and FIG. 4, in an initial state, a movement direction of an output end of the X-axis moving assembly 20 is defined as an X-axis direction C, a movement direction of an output end of the Y-axis moving assembly 40 is defined as a Y-axis direction A, and a movement direction of an output end of the Z-axis moving assembly 30 is defined as a Z-axis direction B. A coordinate system is established between the output end of the first A-axis moving assembly 50 and the output end of the second A-axis moving assembly 60 based on the X-axis direction C, the Y-axis direction A, and the Z-axis direction B, making a first dental prosthesis fixture at the output end of the first A-axis moving assembly 50 and a second dental prosthesis fixture at the output end of the second A-axis moving assembly 60 be rotatable around the X-axis direction C.

Based on this, a first end of the B-axis moving assembly 70 is connected to the first A-axis moving assembly 50, and a second end of the B-axis moving assembly 70 is connected to the second A-axis moving assembly 60, making the B-axis moving assembly 70 be capable of driving the first A-axis moving assembly 50 and the second A-axis moving assembly 60 to rotate. It should be noted that when the first A-axis moving assembly 50 or the second A-axis moving assembly 60 rotates, a coordinate system of the first A-axis moving assembly 50 or the second A-axis moving assembly 60 rotates accordingly.

When a dental prosthesis blank needs to be processed, the B-axis moving assembly 70 is driven by the X-axis moving assembly 20 to move, and the first A-axis moving assembly 50 and the second A-axis moving assembly 60 are driven to reach a needed height. Then, the Z-axis moving assembly 30 is driven by the Y-axis moving assembly 40 to move in the Y-axis direction A. Before the Z-axis moving assembly 30 reaches the first dental prosthesis fixture or the second dental prosthesis fixture, the cutting spindle is driven by the Z-axis moving assembly 30 to move in the Z-axis direction B, thereby processing the dental prosthesis blank through the tool on the cutting spindle. In addition, the first A-axis moving assembly 50 and the second A-axis moving assembly 60 are capable of being driven by the B-axis moving assembly 70 to rotate. The first A-axis moving assembly 50 and the second A-axis moving assembly 60 are configured to rotate around the X-axis direction, thereby processing different positions of the dental prosthesis blank. Through multi-axis co-location, precise location of the tool in three-dimensional space is implemented, a to-be-required position of the dental prosthesis blank can be accurately reached, a position offset in a processing process is effectively avoided, and processing precision is ensured.

Further, in some embodiments of the present disclosure, a first protective enclosure is further included, a first accommodating space is provided in the first protective enclosure, the first protective enclosure is connected to the first A-axis moving assembly 50, and the first A-axis moving assembly 50 is located in the first accommodating space. A second protective enclosure is further included, a second accommodating space is provided in the second protective enclosure, the second protective enclosure is connected to the second A-axis moving assembly 60, and the second A-axis moving assembly 60 is located in the second accommodating space. A side that is of the first protective enclosure and that is close to the first end of the B-axis moving assembly 70 is provided with a first slot, and the first A-axis moving assembly 50 passes through the first slot and is connected to the first end of the B-axis moving assembly 70. A side that is of the second protective enclosure and that is close to the second end of the B-axis moving assembly 70 is provided with a second slot, and the second A-axis moving assembly 60 passes through the second slot and is connected to the second end of the B-axis moving assembly 70.

In this embodiment, the first A-axis moving assembly 50 is located in the first accommodating space provided in the first protective enclosure, the second A-axis moving assembly 60 is located in the second accommodating space provided in the second protective enclosure, the side that is of the first protective enclosure and that is close to the first end of the B-axis moving assembly 70 is provided with the first slot, and the side that is of the second protective enclosure and that is close to the second end of the B-axis moving assembly 70 is provided with the second slot. In this way, during subsequent processing, the X-axis moving assembly 20 is prevented from driving the B-axis moving assembly 70 to move too high or too low, and therefore, reliability of a device is improved.

Specifically, a processing opening is provided on each of the side that is of the first protective enclosure and that is close to the cutting spindle and the side that is of the second protective enclosure and that is close to the cutting spindle. The cutting spindle is driven by the Z-axis moving assembly 30 to pass through the processing opening to process the dental prosthesis blank (namely, the dental prosthesis blank on the first dental prosthesis fixture or the second dental prosthesis fixture) in the first protective enclosure or the second protective enclosure.

Further, in some embodiments of the present disclosure, a dry cutting dust collector 80 is further included. The dry cutting dust collector 80 is connected to the housing, the dry cutting dust collector 80 is located in the cavity, and the dry cutting dust collector 80 is electrically connected to the controller 10. A first notch is provided on the first protective enclosure, the first protective enclosure is connected to the dry cutting dust collector 80 at the first notch through first tubing, and the dry cutting dust collector 80 is configured to adsorb dust generated during dental prosthesis processing.

In this embodiment, the dry cutting dust collector 80 is connected to the first protective enclosure at the first notch through the first tubing, thereby adsorbing dust generated during dry-cutting processing, ensuring stability and accuracy in the processing process, and improving processing precision and quality of a product.

Further, in some embodiments of the present disclosure, a cutting fluid circulation module 90 is further included. The cutting fluid circulation module 90 is connected to the housing, the cutting fluid circulation module 90 is located in the cavity, and the cutting fluid circulation module 90 is electrically connected to the controller 10. A second notch is provided on the second protective enclosure, the second protective enclosure is connected to the cutting fluid circulation module 90 at the second notch through second tubing, the cutting fluid circulation module 90 is configured to circulate a cutting fluid, a water pump is disposed on the Z-axis moving assembly 30, an input end of the water pump is connected to the cutting fluid circulation module 90, and an output end of the water pump is capable of spraying water toward the tool.

In this embodiment, the cutting fluid circulation module 90 is connected to the second protective enclosure at the second notch through the second tubing, to collect the cutting fluid. Based on this, the water pump is disposed on the Z-axis moving assembly 30, the input end of the water pump is connected to the cutting fluid circulation module 90, and the output end of the water pump is capable of spraying water toward the tool, thereby meeting a wet-cutting condition.

Further, in some embodiments of the present disclosure, a tool magazine and a tool setter are further included. The tool magazine is connected to the X-axis moving assembly 20, and a plurality of tools are disposed on the tool magazine. The tool setter is connected to the X-axis moving assembly 20.

In this embodiment, when a tool needs to be replaced, the tool magazine is driven by the X-axis moving assembly 20 to move to a height the same as a height of the cutting spindle, making the Y-axis moving assembly 40 drive the Z-axis moving assembly 30 move to a specified position in the Y-axis direction, and replacing the tool through the Z-axis moving assembly 30. Based on this, the tool setter is driven by the X-axis moving assembly 20 to move to a height the same as the height of the cutting spindle, thereby calibrating a position of the tool.

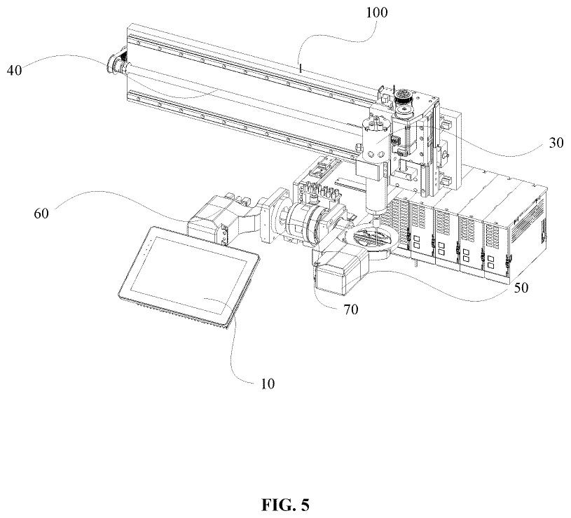

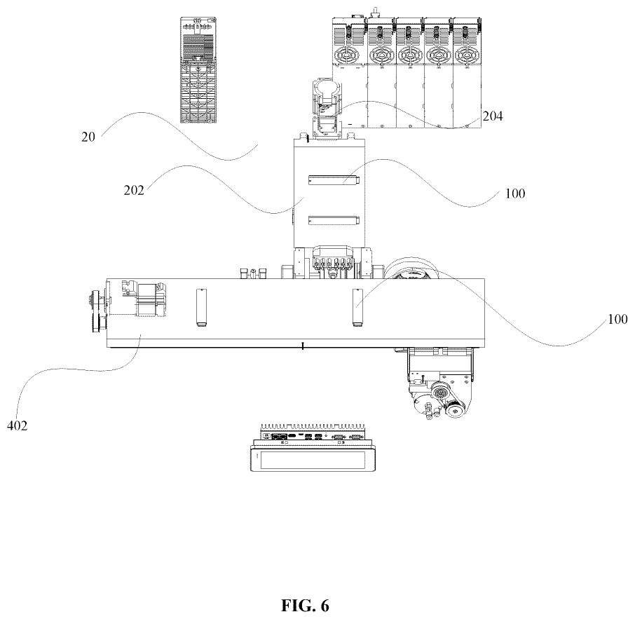

Further, as shown in FIG. 5 and FIG. 6, in some embodiments of the present disclosure, temperature sensors 100 and actuating elements are further included. There are a plurality of temperature sensors 100, and the plurality of temperature sensors 100 are mounted on the X-axis moving assembly 20 and the Y-axis moving assembly 40, and the temperature sensors 100 are electrically connected to the controller 10. There are a plurality of actuating elements, the actuating elements are mounted on the X-axis moving assembly 20 and the Y-axis moving assembly 40, the actuating elements are electrically connected to the controller 10, and the actuating elements are configured to heat up. In the initial state, the X-axis moving assembly 20 is configured to drive the B-axis moving assembly 70 to move in the X-axis direction C, the Y-axis moving assembly 40 is configured to drive the Z-axis moving assembly 30 to move in the Y-axis direction A, the Z-axis moving assembly 30 is configured to drive the cutting spindle to move in the Z-axis direction B, and the first A-axis moving assembly 50 and the second A-axis moving assembly 60 are configured to rotate around the X-axis direction C.

In this embodiment, the plurality of temperature sensors 100 are mounted on the X-axis moving assembly 20 and the Y-axis moving assembly 40, to obtain a temperature of the X-axis moving assembly 20 and a temperature of the Y-axis moving assembly 40 through the plurality of temperature sensors 100. Then, the actuating elements are controlled by the controller 10 to heat up, to keep a precision value of an overall system to be within a most stable range.

By mounting the plurality of temperature sensors 100, temperature changes of these key components can be monitored by the system in real time, to reduce a system error caused by the temperature changes. Therefore, overall stability of the system is improved, and reliability of the system is improved.

Specifically, a communication module is further included, and the communication module is electrically connected to the controller 10.

Further, in some embodiments of the present disclosure, as shown in FIG. 5, the X-axis moving assembly 20 includes a first base plate 202 and an X-axis servo motor 204. The first base plate 202 is connected to the X-axis servo motor 204, the X-axis servo motor 204 is located on a first side of the first base plate 202, the temperature sensor 100 is connected to the first base plate 202, the temperature sensor 100 is located on a second side that is of the first base plate 202 and that is away from the X-axis servo motor 204, the actuating elements are connected to the first base plate 202, and the actuating elements are respectively located on a third side and a fourth side of the first base plate 202.

In this embodiment, the X-axis servo motor 204 is located on the first side of the first base plate 202, the temperature sensor 100 is located on the second side that is of the first base plate 202 and that is away from the X-axis servo motor 204, the actuating elements are connected to the first base plate 202, and the actuating elements are respectively located on the third side and the fourth side of the first base plate 202. When a temperature detected by the temperature sensor 100 is not within a most stable range, the actuating element is controlled to heat up, to ensure stability and reliability of the system temperature.

Further, in some embodiments of the present disclosure, the Y-axis moving assembly 40 includes a second base plate 402 and a Y-axis servo motor. The second base plate 402 is connected to the Y-axis servo motor, the temperature sensor 100 is connected to the second base plate 402, the temperature sensor 100 is located on a side of the second base plate 402, the actuating element is connected to the second base plate 402, and the actuating element is located on a surface that is of the second base plate 402 and that is away from the Y-axis servo motor.

In this embodiment, the temperature sensor 100 is located on a side of the second base plate 402, and the actuating element is located on a surface that is of the second base plate 402 and that is away from the Y-axis servo motor. When a temperature detected by the temperature sensor 100 is not within the most stable range, the actuating element is controlled to heat up, to ensure stability and reliability of the system temperature.

Further, in some embodiments of the present disclosure, an X-axis servo driver, a Y-axis servo driver, a Z-axis servo driver, a first A-axis servo driver, and a second A-axis servo driver are further included. The X-axis servo driver is electrically connected to the X-axis moving assembly 20, the X-axis servo driver is electrically connected to the controller 10, and the X-axis moving assembly 20 is located in the cavity. The Y-axis servo driver is electrically connected to the Y-axis moving assembly 40, the Y-axis servo driver is electrically connected to the controller 10, and the Y-axis moving assembly 40 is located in the cavity. The Z-axis servo driver is electrically connected to the Z-axis moving assembly 30, the Z-axis servo driver is electrically connected to the controller 10, and the Z-axis moving assembly 30 is located in the cavity. The first A-axis servo driver is electrically connected to the first A-axis moving assembly 50, the first A-axis servo driver is electrically connected to the controller 10, and the first A-axis moving assembly 50 is located in the cavity. The second A-axis servo driver is electrically connected to the second A-axis moving assembly 60, the second A-axis servo driver is electrically connected to the controller 10, and the second A-axis moving assembly 60 is located in the cavity.

Further, in some embodiments of the present disclosure, a frequency converter and a barometric pressure sensor are further included. The frequency converter is located in the cavity, and the frequency converter is electrically connected to the controller 10. The barometric pressure sensor is located in the cavity, and the barometric pressure sensor is electrically connected to the controller 10.

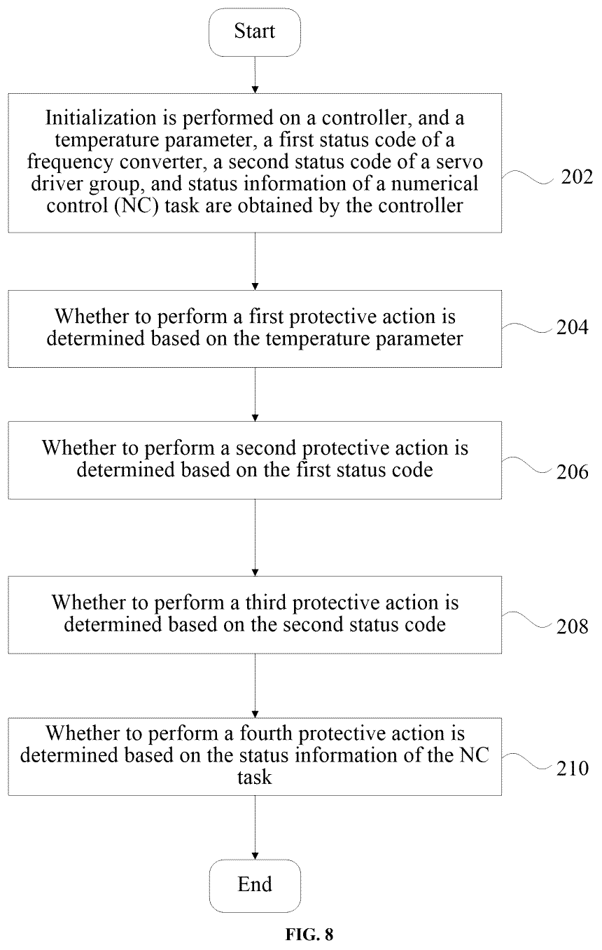

According to a second aspect of the present disclosure, a control method of a dental engraving and milling machine is provided. As shown in FIG. 8, the control method is used for the dental engraving and milling machine according to any embodiment, and includes the following steps.

In step 202, initialization is performed on a controller 10, and a temperature parameter, a first status code of a frequency converter, a second status code of a servo driver group, and status information of a numerical control (NC) task are obtained by the controller 10.

In step 204, whether to perform a first protective action is determined based on the temperature parameter.

In step 206, whether to perform a second protective action is determined based on the first status code.

In step 208, whether to perform a third protective action is determined based on the second status code.

In step 210, whether to perform a fourth protective action is determined based on the status information of the NC task.

The present disclosure provides a control method of an intelligent dental engraving and milling machine. First, initialization is performed on a controller 10, a temperature parameter is obtained by the controller 10 via the temperature sensor 100, and a first status code of a frequency converter, a second status code of a servo driver group, and status information of a NC task are obtained by the controller 10.

Then, a status of the intelligent dental engraving and milling machine is determined sequentially based on the temperature parameter, the first status code, the second status code, and the status information of the NC task, and a corresponding protective action is performed based on a determined result. The protective action includes a first protective action, a second protective action, a third protective action, and a fourth protective action.

The protective action is performed by the temperature sensor 100 by obtaining the temperature parameter, to ensure stability and precision in a processing process. In addition, the status of the engraving and milling machine is determined based on monitoring data and a corresponding protective action (for example, the first protective action, the second protective action, the third protective action, and the fourth protective action) is performed, to ensure safe operation of a device in different conditions, and improve reliability of the device.

Further, in some embodiments of the present disclosure, the determining whether to perform a first protective action based on the temperature parameter includes the following steps. It is determined whether the temperature parameter is within a preset temperature range, it is determined that a temperature is normal if the temperature parameter is within the preset temperature range, and the first protective action is performed by an actuating element if the temperature range is not within the preset temperature range, where the first preset temperature range is from 28° C. to 50° C.

In this embodiment, it is determined whether the temperature parameter is within the preset temperature range. If the temperature parameter is within the preset temperature range, it is determined that the temperature is normal. If the temperature parameter is not within the present temperature, the first protective action is performed by the actuating element. The preset temperature range is from 28° C. to 50° C.

It should be noted that, when a temperature of a metal machine bed of the dental engraving and milling machine is from 30° C. to 50° C. due to a material problem, a precision value of an overall system is within a most stable range. In this case, a lower limit of the preset temperature range is directly set to 30° C., and therefore, a moment for performing the first protective action may be too early. If a temperature is set to be extremely low, inaccuracy may be caused. Therefore, 28° C. is selected as a lower limit value of the preset temperature range in the present disclosure, to ensure timely corresponding processing, and avoid that the first protective action is performed too lately due to an extremely low lower limit of the preset temperature range. Therefore, costs, overall electric power and heat-up uniformity are balanced.

Specifically, the first protective action includes: When the temperature parameter is lower than 28° C., the actuating element is controlled by the controller 10 to heat up until a temperature detected by the temperature sensor 100 is greater than 28° C. When the temperature parameter is higher than 28° C., the actuating element is controlled by the controller 10 to turn off heat-up.

Specifically, when the temperature parameter is lower than the lower limit (namely, 28° C.) of the preset temperature range, and a difference between the temperature parameter and the lower limit of the preset temperature range exceeds a preset threshold, it is determined that the temperature of the device is too low, and the actuating element is controlled by the controller 10 to reach a first voltage, to implement quick heat generation. If the temperature parameter is lower than the lower limit (namely, 28° C.) of the preset temperature range and the difference between the temperature parameter and the lower limit of the preset temperature range does not exceed the preset threshold, it is determined that the temperature of the device is close to the preset temperature range, and the actuating element is controlled by the controller 10 to reach a second voltage, to implement slow heat generation. The first voltage is greater than the second voltage. (Preferably, the first voltage is far greater than the second voltage).

Specifically, when the temperature parameter is lower than an upper limit (namely, 50° C.) of the preset temperature range, the actuating element is controlled by the controller 10 to turn off, and the temperature parameter is restored to the preset temperature range through self-cooling of the device.

Specifically, a corresponding actuating element may be selectively turned off by the controller 10 according to different signals from a temperature sensor 100, thereby improving overall flexibility.

Further, in some embodiments of the present disclosure, the determining whether to perform a second protective action based on the first status code includes the following steps. It is determined whether the first status code is zero, it is determined that a device status is abnormal if the first status code is zero, a first error code is obtained, correlations between the first error code and a voltage, a load current, as well as a short-circuit fault are sequentially analyzed, a first abnormal element is obtained, the second protective action is performed based on the first abnormal element, and it is determined that the device status is normal if the first status code is not zero.

Specifically, the second protective action includes stopping outputting and broadcasting error information when any condition of frequency converter over-current, motor operation over-current, frequency converter overheating, frequency loss in the frequency converter, too high input voltage of the frequency converter, input frequency loss in the frequency converter, and motor overload occurs.

Further, in some embodiments of the present disclosure, the determining whether to perform a third protective action based on the second status code includes the following steps. It is sequentially determined whether second status codes of all servo drivers in the servo driver group are zero, it is determined that a device status is abnormal if the second status code of any servo driver is zero, a second error code is obtained, correlations between the second error code and a voltage, a load current, as well as a short-circuit fault are sequentially analyzed, a second abnormal element is obtained, the third protective action is performed based on the second abnormal element, and it is determined that the device status is normal if the second status codes of all servo drivers are not zero.

Further, in some embodiments of the present disclosure, the determining whether to perform a fourth protective action based on the status information of the NC task includes the following steps. Correlations between the status information of the NC task and startup, pause, completion, as well as exception interrupt are sequentially analyzed, and a status text of the NC task is obtained; a protective instruction is obtained based on the status text; and the fourth protective action is performed based on the protective instruction.

Specifically, the fourth protective action includes: When a motion axis range exceeds, an error message is popped up on a screen of the controller 10. When the status information of the NC task is pause, the operation is paused. When the status information of the NC task is stop, the operation is stopped.

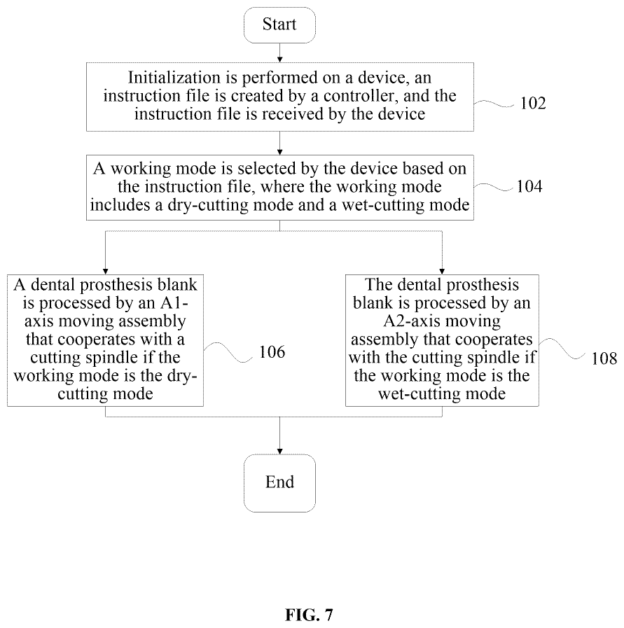

According to a third aspect of the present disclosure, a control method of a dental engraving and milling machine is provided. As shown in FIG. 7, the control method is used for the dental engraving and milling machine according to any embodiment, and includes the following steps.

In step 102, initialization is performed on a device, an instruction file is created by a controller 10, and the instruction file is received by the device.

In step 104, a working mode is selected by the device based on the instruction file, where the working mode includes a dry-cutting mode and a wet-cutting mode.

In step 106, a dental prosthesis blank is processed by a first A-axis moving assembly 50 that cooperates with a cutting spindle if the working mode is the dry-cutting mode.

In step 108, the dental prosthesis blank is processed by a second A-axis moving assembly 60 that cooperates with the cutting spindle if the working mode is the wet-cutting mode.

According to the control method of the dental engraving and milling machine provided in the third aspect of the present disclosure, first, initialization is performed on the device, the instruction file is created by the controller 10, and the instruction file is received by the device.

Then, the working mode is selected by the device based on the instruction file, where the working mode includes the dry-cutting mode and the wet-cutting mode. The first A-axis moving assembly 50 or the second A-axis moving assembly 60 is selectively controlled to cooperate with the cutting spindle, to process the dental prosthesis blank.

Further, in some embodiments of the present disclosure, that an instruction file is created by a controller 10 includes the following steps. A serial number of the integrated dental engraving and milling machine and a fixture are selected; a dental prosthesis blank is selected based on a material characteristic and a scaling ratio; three-dimensional data of to-be-required dental prosthesis is determined based on a requirement of the to-be-required dental prosthesis; a working mode is determined based on the dental prosthesis blank; a selection instruction of a protective enclosure, a water pump working instruction and a dust collection working instruction are determined based on the working mode; and a rotation speed of the cutting spindle is determined based on the three-dimensional data of the to-be-required dental prosthesis.

In this embodiment, first, the serial number of the integrated dental engraving and milling machine and the fixture are selected, then, the dental prosthesis blank is selected based on the material characteristic and the scaling ratio, and the three-dimensional data of the to-be-required dental prosthesis is determined based on a requirement of the to-be-required dental prosthesis.

The dry-cutting mode and the wet-cutting mode are usually selected according to the material, and therefore, the working mode is determined based on the dental prosthesis blank, and the selection instruction of the protective enclosure, the water pump working instruction and the dust collection working instruction are further determined based on the working mode.

Finally, the rotation speed of the cutting spindle is determined based on the three-dimensional data of the to-be-required dental prosthesis.

Further, in some embodiments of the present disclosure, that a dental prosthesis blank is processed by a first A-axis moving assembly 50 that cooperates with a cutting spindle if the working mode is the dry-cutting mode includes the following steps. A first movement range of an output end of the Y-axis moving assembly 40 is set; the cutting spindle is controlled to rotate based on the rotation speed of the cutting spindle; on and off the dry cutting dust collector 80 are controlled based on the dust collection working instruction; an operation power of the dry cutting dust collector 80 is adjusted based on machining allowance; and the dental prosthesis blank is processed based on the three-dimensional data of the to-be-required dental prosthesis.

In this embodiment, first, the first movement range of the output end of the Y-axis moving assembly 40 is set, where the first movement range is used to make a stroke of the output end of the Y-axis moving assembly 40 be in a dry-cutting environment. In other words, the output end of the Y-axis moving assembly 40 is near the first A-axis moving assembly 50, to ensure that the dental prosthesis blank on the first A-axis moving assembly 50 is processed by the Z-axis moving assembly 30 connected to the output end of the Y-axis moving assembly 40.

Then, the cutting spindle is controlled to rotate based on the rotation speed of the cutting spindle, on and off of the dry cutting dust collector 80 are controlled based on the dust collection working instruction, the operation power of the dry cutting dust collector 80 is adjusted according to the machining allowance, and finally, the dental prosthesis blank is processed based on the three-dimensional data of the to-be-required dental prosthesis.

Further, in some embodiments of the present disclosure, that a dental prosthesis blank is processed by a second A-axis moving assembly 60 that cooperates with a cutting spindle if the working mode is the wet-cutting mode includes the following steps. A second movement range of an output end of the Y-axis moving assembly 40 is set; the cutting spindle is controlled to rotate based on the rotation speed of the cutting spindle; on and off of a water pump are controlled based on the water pump working instruction; and the dental prosthesis blank is processed based on the three-dimensional data of the to-be-required dental prosthesis.

In this embodiment, the second movement range of the output end of the Y-axis moving assembly 40 is set, where the second movement range is used to make a stroke of the output end of the Y-axis moving assembly 40 be in a wet-cutting environment. In other words, the output end of the Y-axis moving assembly 40 is near the second A-axis moving assembly 60, to ensure that the dental prosthesis blank on the second A-axis moving assembly 60 is processed by the Z-axis moving assembly 30 connected to the output end of the Y-axis moving assembly 40.

Then, the cutting spindle is controlled to rotate based on the rotation speed of the cutting spindle, on and off of the water pump are controlled based on the water pump working instruction, and finally, the dental prosthesis blank is processed based on the three-dimensional data of the to-be-required dental prosthesis.

Further, in some embodiments of the present disclosure, that an operation power of a dry cutting dust collector is adjusted according to machining allowance includes the following steps. The dry cutting dust collector 80 is set to operate at a first power if the machining allowance is first machining allowance; the dry cutting dust collector 80 is set to operate at a second power if the machining allowance is second machining allowance; and the dry cutting dust collector 80 is set to operate at a third power if the machining allowance is third machining allowance. The first power is greater than the second power that is greater than the third power, and the first machining allowance is greater than the second machining allowance that is greater than the third machining allowance.

In this embodiment, the dry cutting dust collector 80 is set to work at different powers according to different machining allowance.

The dry cutting dust collector 80 is set to operate at the first power if the machining allowance is the first machining allowance. The dry cutting dust collector 80 is set to operate at the second power if the machining allowance is the second machining allowance. The dry cutting dust collector 80 is set to operate at the third power if the machining allowance is the third machining allowance. The first power is greater than the second power that is greater than the third power, and the first machining allowance is greater than the second machining allowance that is greater than the third machining allowance.

In this way, during working with the first machining allowance, the dry cutting dust collector 80 is operated at the highest first power due to a large cutting portion. During working with the second machining allowance, the dry cutting dust collector 80 is operated at the moderate second power due to a moderate cutting portion. During working with the third machining allowance, the dry cutting dust collector 80 is operated at the lowest second power due to a small cutting portion.

Specifically, the first machining allowance, the second machining allowance, and the third machining allowance can be used to allow different tools to perform processing.

Specifically, the first machining allowance is 0.25 mm, the second machining allowance is 0.1 mm, and the third machining allowance is used to make size allowance of a final product be 0.

Calibration of an existing dental engraving and milling machine is to clamp a special material with a fixture at a special position to cut a standard block, measure an actual value of the standard block after cutting is completed to reversely measure a zero point offset of each axis, and manually or automatically calibrate a zero point value of a motion axis, to complete zero-point calibration of the dental engraving and milling machine. In the method, materials are wasted, and it is difficult to ensure calibration accuracy due to limitation to a measuring tool of an operator, difference to measurement rigor, and the like.

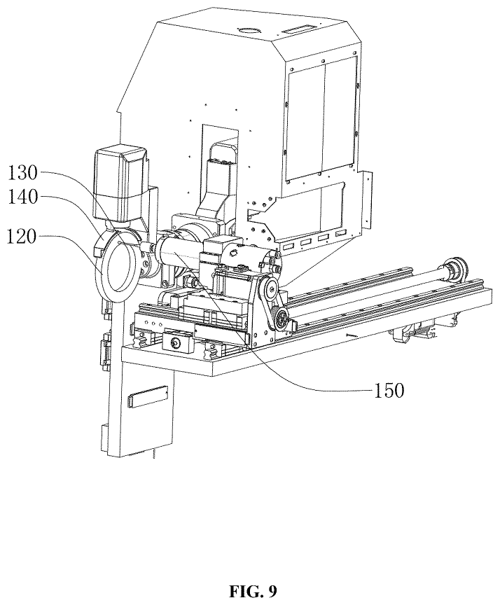

Further, as shown in FIG. 9, in some embodiments of the present disclosure, a calibration jig 120 and a photoelectric sensor 130 are included. The calibration jig 120 is detachably mounted on a first fixture 140. The photoelectric sensor 130 is detachably mounted on a spindle, and the photoelectric sensor 130 is driven by the spindle to sense a structure of the calibration jig 120, to perform zero-point calibration on the motion axis of the dental engraving and milling machine. Specifically, the spindle is a processing spindle for clamping a tool during processing. The calibration jig 120 is clamped by the first fixture 140, the photoelectric sensor 130 is clamped by a pair of lobster-claw forceps of the spindle, the first fixture 140 and the spindle are controlled to move, the calibration jig 120 and the photoelectric sensor 130 are driven to move, and the calibration jig 120 cooperates with the photoelectric sensor 130 to perform zero-point calibration on the motion axis of the dental engraving and milling machine.

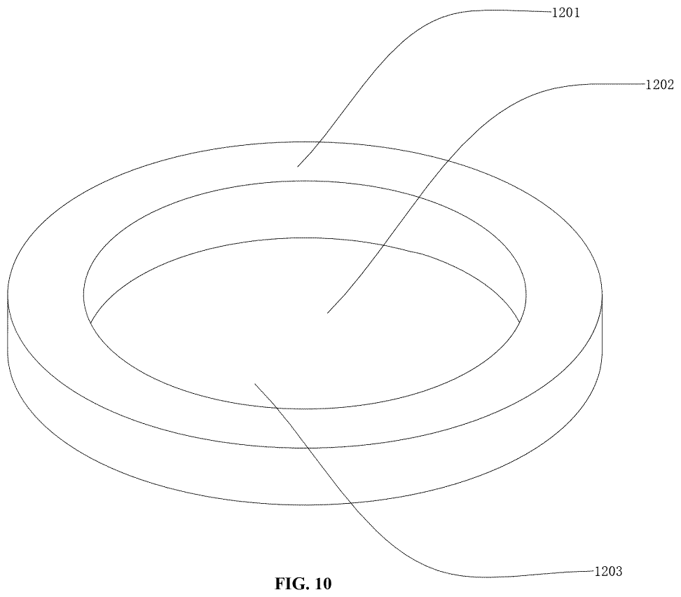

Further, as shown in FIG. 10, in some embodiments of the present disclosure, the calibration jig 120 includes a calibration ring 1201, a measurement through hole 1202 is provided on a center position of the calibration ring 1201, a bottom of the measurement through hole 1202 is fixedly connected to a calibration surface 1203, and the photoelectric sensor 130 is configured to perform zero-point calibration on the motion axis of the dental engraving and milling machine by identifying a structure of the calibration ring 1201 and a structure of the calibration surface 1203.

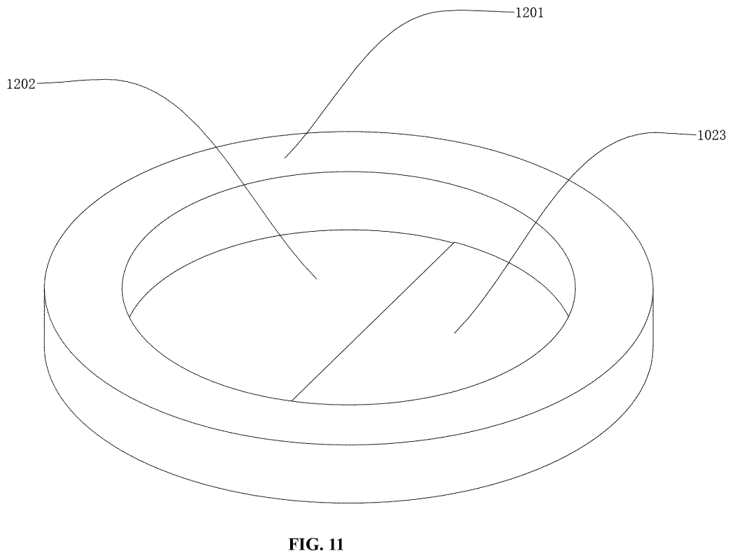

Further, as shown in FIG. 10, in some embodiments of the present disclosure, the calibration surface 1203 may be a circular surface matched with the measurement through hole 1202. In addition, to further save materials and facilitate observation by staff during mounting, as shown in FIG. 11, the calibration surface 1203 may alternatively be a semicircular surface matched with the measurement through hole 1202.

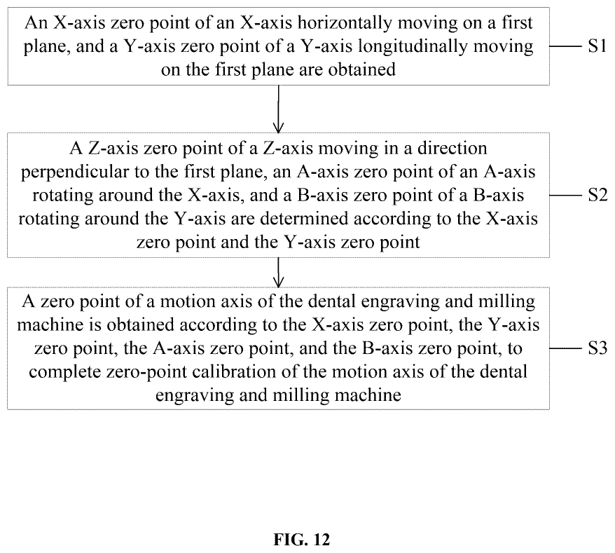

Another objective of the present disclosure is to provide a calibration method of a dental engraving and milling machine. The calibration method is used for the dental engraving and milling machine, and as shown in FIG. 12, includes the following steps.

In step S1, an X-axis zero point of an X-axis horizontally moving on a first plane, and a Y-axis zero point of a Y-axis longitudinally moving on the first plane are obtained.

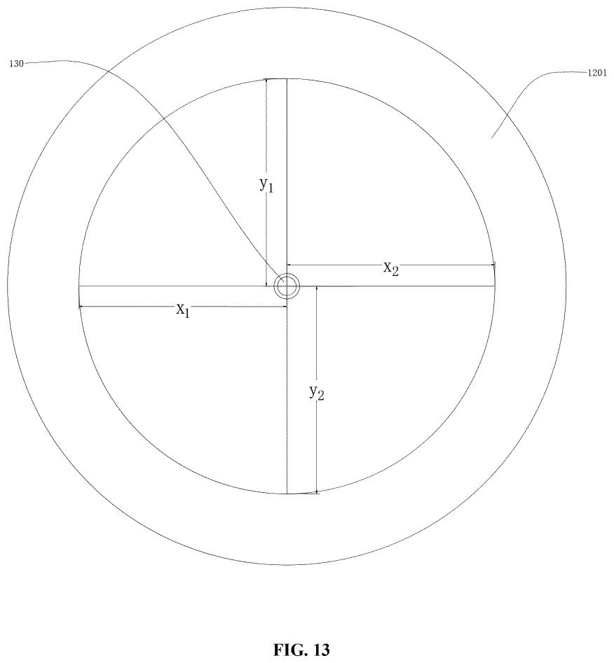

As shown in FIG. 13, that an X-axis zero point is obtained includes the following steps.

A spindle is controlled to move a sensing end head of a photoelectric sensor into a measurement through hole, and the sensing end head of the photoelectric sensor is located above a calibration surface, to avoid a measurement error due to contact between the sensing end head and the calibration surface.

The photoelectric sensor is controlled to move forward along an X-axis until an edge of the measurement through hole is detected by the sensing end head of the photoelectric sensor, the X-axis is stopped, and a first X-axis measurement value x₁ when the photoelectric sensor moves forward along the X-axis is recorded.

The photoelectric sensor is controlled to move reversely along the X-axis until the edge of the measurement through hole is detected by the sensing end head of the photoelectric sensor, the X-axis is stopped, and a second X-axis measurement value x₂ when the photoelectric sensor moves reversely along the X-axis is recorded.

A position parameter x₀ of the X-axis zero point is obtained according to the first X-axis measurement value x₁ and the second X-axis measurement value x₂, where

a calculation formula of the position parameter x₀ of the X-axis zero point is as follows:

$${x}_{0} = \frac{{x}_{1} + {x}_{2}}{2} .$$

Coordinates (x₀, 0) of the X-axis zero point are obtained.

As shown in FIG. 13, that a Y-axis zero point is obtained includes the following steps.

A spindle is controlled to move a sensing end head of a photoelectric sensor into a measurement through hole, and the sensing end head of the photoelectric sensor is located above a calibration surface, to avoid a measurement error due to contact between the sensing end head and the calibration surface.

The photoelectric sensor is controlled to move forward along a Y axis until an edge of the measurement through hole is detected by the sensing end head of the photoelectric sensor, the Y-axis is stopped, and a first Y-axis measurement value y₁ when the photoelectric sensor moves forward along the Y-axis is recorded.

The photoelectric sensor is controlled to move reversely along the Y axis until the edge of the measurement through hole is detected by the sensing end head of the photoelectric sensor, the Y-axis is stopped, and a second Y-axis measurement value y₂ when the photoelectric sensor moves reversely along the Y-axis is recorded.

A position parameter y₀ of the Y-axis zero point is obtained according to the first X-axis measurement value y₁ and the second X-axis measurement value y₂, where

a calculation formula of the position parameter y₀ of the X-axis zero point is as follows:

$${y}_{0} = \frac{{y}_{1} + {y}_{2}}{2} .$$

Coordinates (0, y₀) of the Y-axis zero point are obtained.

In step S2, a Z-axis zero point of a Z-axis moving in a direction perpendicular to the first plane, an A-axis zero point of an A-axis rotating around the X-axis, and a B-axis zero point of a B-axis rotating around the Y-axis are determined according to the X-axis zero point and the Y-axis zero point.

That a Z-axis zero point is obtained includes the following steps.

Origin coordinates (x₀, y₀) of the first plane are determined according to the X-axis zero point and the Y-axis zero point.

The photoelectric sensor is controlled to be located at a coordinate origin (x₀, y₀) position of the first plane, the photoelectric sensor is moved along the Z-axis until the sensing end head of the photoelectric sensor is in contact with a calibration surface, the Z-axis is stopped, and coordinates (x₀, y₀, z₀) of the Z-axis zero point are obtained, where a contact position is a position z₀ of the zero-axis zero point.

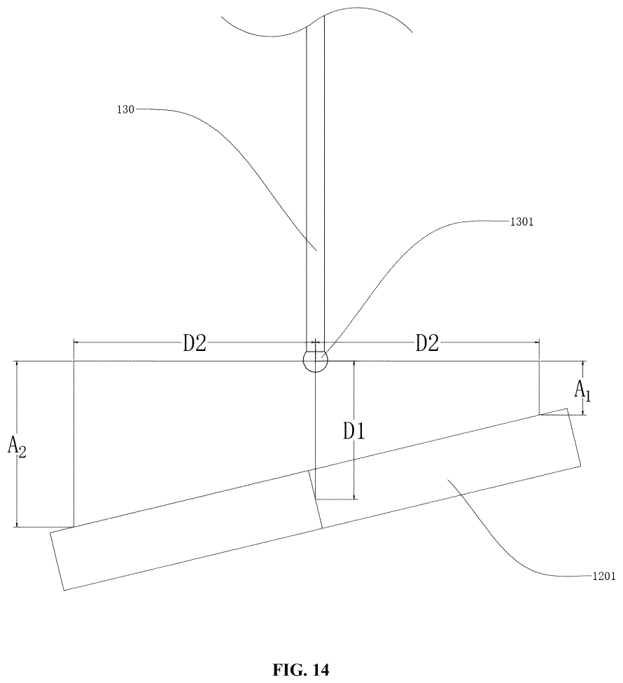

As shown in FIG. 14, that an A-axis zero point is obtained includes the following steps.

Origin coordinates (x₀, y₀) of the first plane are determined according to the X-axis zero point and the Y-axis zero point.

The sensing end head of the photoelectric sensor is controlled to be located at a coordinate origin (x₀, y₀) position of the first plane.

After the sensing end head of the photoelectric sensor is controlled to move for a first distance D1 along the Z-axis in a direction away from a calibration jig, the photoelectric sensor is controlled to move forward for a second distance D2 along the Y-axis, to make the sensing end head of the photoelectric sensor be located on an upper surface of a calibration ring.

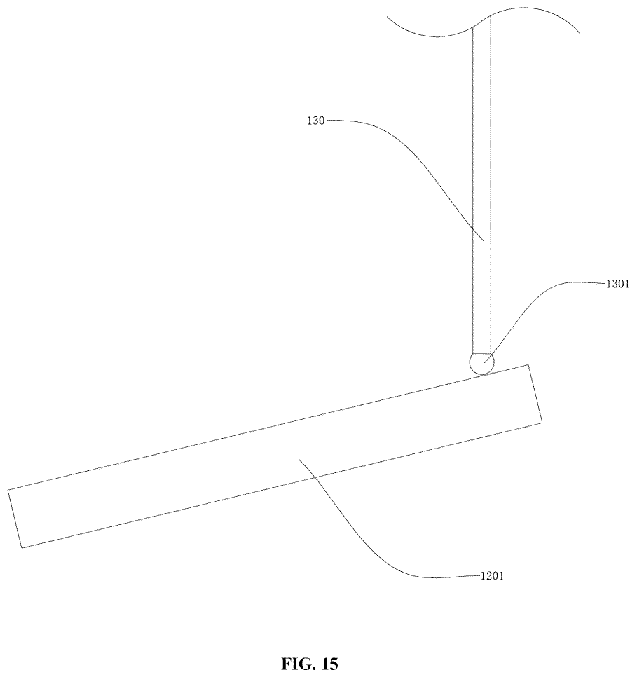

The sensing end head of the photoelectric sensor is controlled to move along the Z-axis in a direction close to the calibration jig to make the sensing end head of the photoelectric sensor be in contact with the upper surface of the calibration ring, as shown in FIG. 15, the Z-axis is stopped, and a first A-axis measurement value A₁ is recorded.

The sensing end head of the photoelectric sensor is controlled to be returned to the coordinate origin (x₀, y₀) position of the first plane.

After the sensing end head of the photoelectric sensor is controlled to move for the first distance D1 along the Z-axis in the direction away from the calibration jig, the photoelectric sensor is controlled to move reversely for the second distance D2 along the Y-axis, to make the sensing end head of the photoelectric sensor 2 be located on the upper surface of the calibration ring.

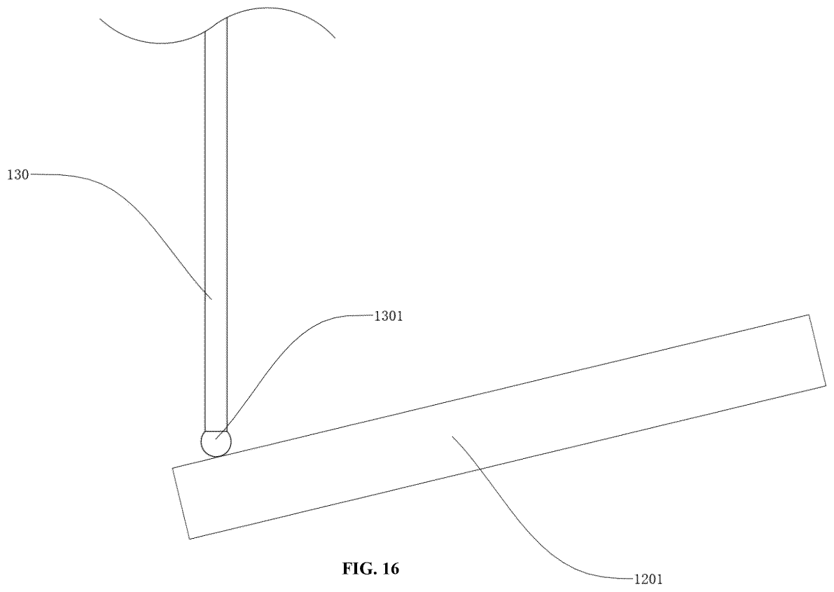

The sensing end head of the photoelectric sensor is controlled to move along the Z-axis in the direction close to the calibration jig to make the sensing end head of the photoelectric sensor be in contact with the upper surface of the calibration ring, as shown in FIG. 16, the Z-axis is stopped, and a second A-axis measurement value A₂ is recorded.

A position parameter A₀ of the A-axis zero point is obtained according to the first A-axis measurement value A₁ and the second A-axis measurement value A₂, where

a calculation formula of the position parameter A₀ of the A-axis zero point is as follows:

$${A}_{0} = \frac{{A}_{1} - {A}_{2}}{2} .$$

Further, that an A-axis zero point is obtained further includes calibration of the A-axis zero point, and the calibration of the A-axis zero point includes the following steps.

When A₀ is negative, as shown in FIG. 6,

after the sensing end head of the photoelectric sensor is controlled to return to the coordinate origin position of the first plane, the sensing end head of the photoelectric sensor is controlled to move for the first distance D1 along the Z-axis in the direction away from the calibration jig, and then the photoelectric sensor is controlled to move reversely for the second distance D2 along the Y-axis, to make the sensing end head 201 of the photoelectric sensor be located on the upper surface of the calibration ring 101.

After the sensing end head of the photoelectric sensor is controlled to move along the Z-axis for a distance of A₂−A₀ in the direction close to the calibration jig, the Z-axis is stopped, the calibration jig is controlled to rotate around the X-axis until the sensing end head of the photoelectric sensor is controlled to be in contact with the upper surface of the calibration ring, thereby completing the calibration of the A-axis zero point.

Similarly, when A₀ is positive,

after the sensing end head of the photoelectric sensor is controlled to return to the coordinate origin position of the first plane, the sensing end head of the photoelectric sensor is controlled to move for the first distance D1 along the Z-axis in the direction away from the calibration jig, and then the photoelectric sensor is controlled to move reversely for the second distance D2 along the Y-axis, to make the sensing end head of the photoelectric sensor be located on the upper surface of the calibration ring.

After the sensing end head of the photoelectric sensor is controlled to move along the Z-axis for a distance of A₁−A₀ in the direction close to the calibration jig, the Z-axis is stopped, the calibration jig is controlled to rotate around the X-axis until the sensing end head of the photoelectric sensor is controlled to be in contact with the upper surface of the calibration ring, thereby completing the calibration of the A-axis zero point.

It should be noted that, the first distance is only a schematic distance in the figure, and may be selected according to an actual situation, provided that the first distance is kept consistent in a process of obtaining the A-axis zero point, and the first distance is kept consistent in a process of calibrating the A-axis zero point. In addition, a principle of obtaining the B-axis zero point is the same as that of obtaining the A-axis zero point, and a same limitation is made to the first distance in the process of obtaining the B-axis zero point and the first distance in the process of obtaining the A-axis zero point.

It should be noted that, the second distance is determined based on a size specification of the calibration jig. When the sensing end head needs to be ensured to move in the direction close to the calibration jig, the sensing end head can be in contact with the upper surface of the calibration ring.

The principle of obtaining the B-axis zero point is the same that of obtaining the A-axis zero point, and therefore, it can be learned that, that a B-axis zero point is obtained includes the following steps.

Origin coordinates of the first plane are determined according to the X-axis zero point and the Y-axis zero point.

The sensing end head of the photoelectric sensor is controlled to be located at a coordinate origin position of the first plane.

After the sensing end head of the photoelectric sensor is controlled to move for a first distance along the Z-axis in a direction away from a calibration jig, the photoelectric sensor is controlled to move forward for a second distance along the X-axis, to make the sensing end head of the photoelectric sensor be located on an upper surface of a calibration ring.

The sensing end head of the photoelectric sensor is controlled to move along the Z-axis in a direction close to the calibration jig to make the sensing end head of the photoelectric sensor be in contact with the upper surface of the calibration ring, the Z-axis is stopped, and a first B-axis measurement value B₁ is recorded.

The sensing end head of the photoelectric sensor is controlled to return to the coordinate origin position of the first plane.

After the sensing end head of the photoelectric sensor is controlled to move for the first distance along the Z-axis in the direction away from the calibration jig, the photoelectric sensor is controlled to move reversely for the second distance along the X-axis, to make the sensing end head of the photoelectric sensor be located on the upper surface of the calibration ring.

The sensing end head of the photoelectric sensor is controlled to move along the Z-axis in the direction close to the calibration jig to make the sensing end head of the photoelectric sensor be in contact with the upper surface of the calibration ring, the Z-axis is stopped, and a second B-axis measurement value B₂ is recorded.

A position parameter B₀ of the B-axis zero point is obtained according to the first B-axis measurement value B₁ and the second B-axis measurement value B₂, where

a calculation formula of the position parameter B₀ of the B-axis zero point is as follows:

$${B}_{0} = \frac{{B}_{1} - {B}_{2}}{2} .$$

In addition, further, that a B-axis zero point is obtained further includes calibration of the B-axis zero point. A calibration principle of the B-axis zero point is the same as that of the A-axis zero point, and therefore, it can be learned that the calibration of the B-axis zero point includes the following steps.

When B₀ is positive,

after the sensing end head of the photoelectric sensor is controlled to return to the coordinate origin position of the first plane, the sensing end head of the photoelectric sensor is controlled to move for the first distance along the Z-axis in the direction away from the calibration jig, and then the photoelectric sensor is controlled to move reversely for the second distance along the X-axis, to make the sensing end head of the photoelectric sensor be located on the upper surface of the calibration ring.

After the sensing end head of the photoelectric sensor is controlled to move along the Z-axis for a distance of B₁−B₀ in the direction close to the calibration jig, the Z-axis is stopped, and the calibration jig is controlled to rotate around the Y-axis until the sensing end head of the photoelectric sensor is controlled to be in contact with the upper surface of the calibration ring, thereby completing calibration of the B-axis zero point.

When B₀ is negative,

after the sensing end head of the photoelectric sensor is controlled to return to the coordinate origin position of the first plane, the sensing end head of the photoelectric sensor is controlled to move for the first distance along the Z-axis in the direction away from the calibration jig, and then the photoelectric sensor is controlled to move reversely for the second distance along the X-axis, to make the sensing end head of the photoelectric sensor be located on the upper surface of the calibration ring.

After the sensing end head of the photoelectric sensor is controlled to move along the Z-axis for a distance of B₂−B₀ in the direction close to the calibration jig, the Z-axis is stopped, and the calibration jig is controlled to rotate around the Y-axis until the sensing end head of the photoelectric sensor is controlled to be in contact with the upper surface of the calibration ring, thereby completing the calibration of the B-axis zero point.

In step S3, a zero point of a motion axis of the dental engraving and milling machine is obtained according to the X-axis zero point, the Y-axis zero point, the A-axis zero point, and the B-axis zero point, to complete the zero-point calibration of the motion axis of the dental engraving and milling machine.

According to the present disclosure, the calibration jig cooperates with the photoelectric sensor to perform zero-point calibration on the motion axis of the dental engraving and milling machine, thereby simplifying the zero-point calibration of the motion axis of the dental engraving and milling machine, improving accuracy of the zero-point calibration of the motion axis of the dental engraving and milling machine, and avoiding waste of materials.

An existing fixture is mostly clamped through a semicircular clamping slot, and therefore, a processing material can only be an adaptive disk-type processing material. However, a processing material of a clamping portion is not involved in processing and forming of a dental prosthesis, and is used to only facilitate clamping of the fixture. In this case, a residual processing material obtained after the dental prosthesis is processed and formed can be only discarded, and consequently, excessive material waste is caused, and production costs are increased.

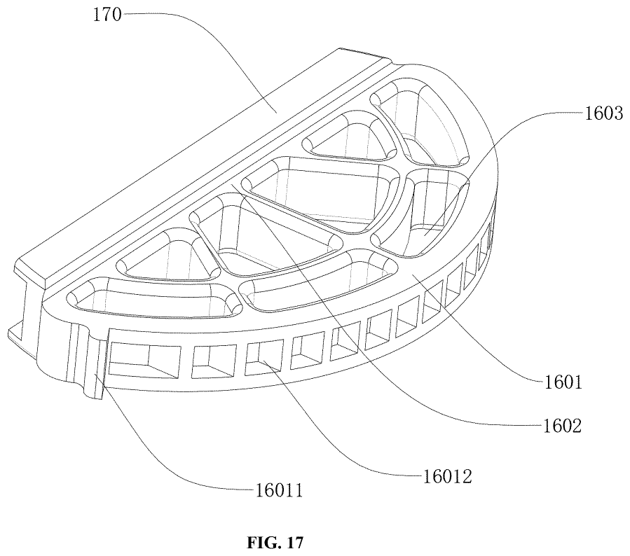

Further, as shown in FIG. 17 to FIG. 19, in some embodiments of the present disclosure, an arched block 160 fixedly connected to a clamping slot of a second fixture 190 is included. An end that is of the arched block 160 and that is away from the clamping slot is fixedly connected to a locating slot 170, and the locating slot 170 is fixedly connected to a processing material. Specifically, the processing material of the clamping portion is replaced with the arched block 160, thereby reducing costs of the processing material. In addition, the arched block 160 can be repeatedly used, further reducing waste of the processing material and reducing production costs.

Further, in some embodiments of the present disclosure, the arched block 160 includes an arc-shaped end 1601 and a straight end 1602. The arc-shaped end 1601 is fixedly connected to the clamping slot, and the straight end 1602 is fixedly connected to the locating slot 170. Specifically, the arc-shaped end 1601 can be adaptive to an existing semicircular clamping slot better, thereby keeping stability of a connection to the clamping slot, providing a flat and regular area through the straight end 1602, and facilitating subsequent mounting of the locating slot 170 and the processing material.

Further, as shown in FIG. 17, in some embodiments of the present disclosure, an angular locating block 16011 is fixedly connected to the arc-shaped end 1601, and the angular locating block 16011 abuts against the edge of the clamping slot, to limit an angle of the arched block 160. Specifically, a mounting angle of the arched block 160 relative to the clamping slot can be precisely limited through the angular locating block 16011, to avoid an inaccurate position of the processing material due to an angular offset. In addition, the arc-shaped end 1601 abuts against the edge of the clamping slot through the angular locating block 16011, to further enhance stability of a connection between the arched block 160 and the clamping slot.

Further, in some embodiments of the present disclosure, weight-reducing grooves 16012 are provided on the arc-shaped end 1601, to effectively reduce integral weight of the arched block 160, reduce a load of the second fixture 190, and reduce mass inertia during rotation of the second fixture 190. Therefore, stability and accuracy of clamping are improved. Optionally, the weight-reducing grooves 16012 may be provided on an arc-shaped plane that is on the arc-shaped end 1601 and that is close to the clamping slot, or may be provided on two opposite end surfaces of the arc-shaped plane. Specifically, the weight-reducing groove 16012 is provided on any position not affecting connection strength of the clamping slot and the arched block 160.

Further, in some embodiments of the present disclosure, the weight-reducing grooves 16012 are symmetrically provided on the arc-shaped end 1601, to ensure balance and stability of the second fixture 190 in a processing process.

Further, in some embodiments of the present disclosure, weight-reducing holes 1603 are distributed on the arched block 160 to further reduce weight of the arched block 160, thereby reducing the load of the second fixture 190 and reducing mass inertia during rotation of the second fixture 190.

Further, in some embodiments of the present disclosure, the weight-reducing holes 1603 are symmetrically distributed on the arched block 160, making the arched block 160 be stressed more uniformly, ensuring balance and stability of the second fixture 190 in a processing process, reducing a vibration or drift possibility, and avoiding structural deformation or a processing error caused by uneven weight distribution.

Further, in some embodiments of the present disclosure, the weight-reducing holes 1603 are distributed in a form of circular array by using a midpoint of a chord on the arched block 160 as a center, making the arched block 160 be stressed more uniformly, keeping high strength and high stability of the structure, further ensuring balance and stability of the second fixture 190 in the processing process, reducing a vibration or drift possibility, and avoiding structural deformation or a processing error caused by uneven weight distribution.

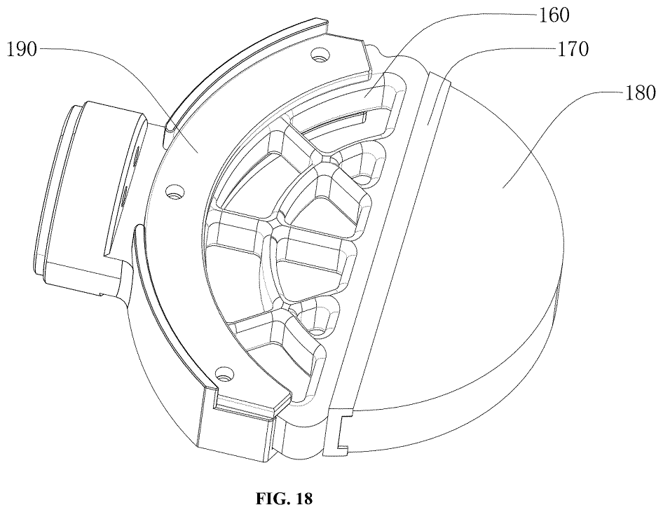

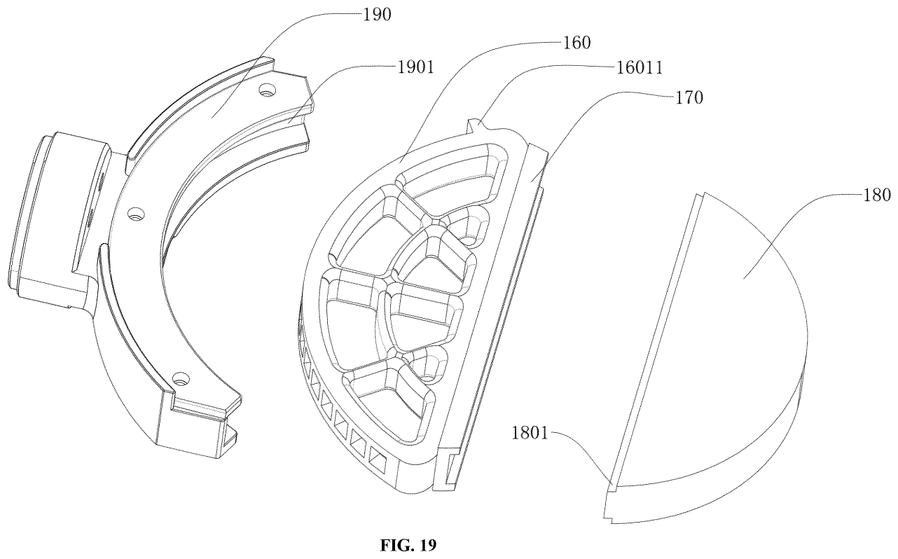

Further, as shown in FIG. 18 and FIG. 19, in some embodiments of the present disclosure, an arched processing material 180 is further included. The arched processing material 180 is bonded with the locating slot 170, and the arched processing material 180 is capable of being adaptive to the structure of the locating slot 170 better, thereby improving utilization of the processing material, and reducing material waste in a conventional disk-shaped material.

Further, as shown in FIG. 19, in some embodiments of the present disclosure, the locating slot 170 is a rectangular groove. A connection bump 1801 matched with the rectangular groove is disposed on the arched processing material 180, and the connection bump 1801 is bonded in the rectangular groove. Specifically, precise alignment can be achieved through a matched design between the rectangular groove and the connection bump 1801 to make the arched processing material 180 and the arched block 160 form a movement integer, thereby reducing a yield caused by a position offset, ensuring mounting stability of the processing material, and facilitating mounting and bonding by the staff.

Further, in some embodiments of the present disclosure, the locating slot 170 is a dovetail slot. A connection bump 1801 matched with the dovetail slot is disposed on the arched processing material 180. The connection bump 1801 is bonded in the dovetail slot after being in mortise-tenon joint to the dovetail slot. Specifically, the design of the dovetail slot has higher connection strength and stability, and can bear higher processing force. On the basis of bonding, a yield caused by loosening or drop of the arched processing material 180 is further reduced through the mortise-tenon joint, and mounting and bonding by the staff is facilitated.

Further, in some embodiments of the present disclosure, an integrally formed structure is adopted to ensure a zero-error connection between the locating slot 170 and the arched block 160, thereby making the clamped arched processing material 180 be accurately located on an ideal plane for processing.

The processing material is connected to the second fixture 190 through the arched block 160, thereby improving functionality and stability of the second fixture 190, improving utilization of the processing material, reducing production cost, and improving processing efficiency and processing precision.

In the claims, specification and drawings of the present disclosure, the term “a plurality of” means two or more. Unless otherwise specifically defined, orientations or position relationships indicated by terms “up”, “down”, and the like are orientations or position relationships as shown in the drawings, and these terms are just used to facilitate description of the present disclosure and simplify the description, but not to indicate or imply that the mentioned apparatus or elements must have a specific orientation and must be established and operated in a specific orientation, and thus, these terms cannot be understood as a limitation to the present disclosure; and terms such as “connection”, “mounting”, and “fastening” should be comprehended in a broad sense. For example, the “connection” may be a fixed connection among a plurality of objects, a detachable connection among a plurality of objects, or an integral connection; or may be a direct connection among a plurality of objects or an indirect connection using an intermediate medium among a plurality of objects. Those of ordinary skill in the art may understand specific meanings of the above terms in the present disclosure based on a specific situation.

In the claims, specification and drawings of the present disclosure, the description with reference to the terms such as “one embodiment”, “some embodiments”, and “a specific embodiment” means that the specific features, structures, materials, or characteristics described with reference to the embodiment or example are included in at least one embodiment or example of the present disclosure. In the claims, specification and drawings of the present disclosure, the schematic descriptions of the above terms do not necessarily refer to the same embodiment or example. Moreover, the specific features, structures, materials, or characteristics described may be combined in any suitable way in any one or more embodiments or examples.

What are described above are merely preferred embodiments of the present disclosure and are not intended to limit the present disclosure, and for those skilled in the art, the present disclosure can be variously modified and changed. Any modifications, equivalent substitutions, improvements, and the like made within the spirit and scope of the present disclosure should be included within the protection scope of the present disclosure.

What is claimed is:

1. A dental engraving and milling machine, comprising:
a housing, wherein a cavity is disposed in the housing;
a controller, wherein the controller is located in the cavity, and the controller is connected to the housing;
an X-axis moving assembly, wherein the X-axis moving assembly is electrically connected to the controller, and the X-axis moving assembly is located in the cavity;
a Z-axis moving assembly, wherein the Z-axis moving assembly is electrically connected to the controller, and the Z-axis moving assembly is located in the cavity;
a cutting spindle, wherein the cutting spindle is connected to an output end of the Z-axis moving assembly, a tool is disposed on the cutting spindle, and the tool is configured to engrave a dental prosthesis blank;
a Y-axis moving assembly, wherein the Y-axis moving assembly is electrically connected to the controller, an output end of the Y-axis moving assembly is connected to the Z-axis moving assembly, the Y-axis moving assembly is located in the cavity, and the Y-axis moving assembly is movable in a third direction;
a first A-axis moving assembly, wherein the first A-axis moving assembly is electrically connected to the controller, a first dental prosthesis fixture is disposed at an output end of the first A-axis moving assembly, and the first A-axis moving assembly cooperates with the cutting spindle to perform dry cutting on the dental prosthesis blank;
a second A-axis moving assembly, wherein the second A-axis moving assembly is electrically connected to the controller, a second dental prosthesis fixture is disposed at an output end of the second A-axis moving assembly, and the second A-axis moving assembly cooperates with the cutting spindle to perform wet cutting on the dental prosthesis blank; and
a B-axis moving assembly, wherein a first end of the B-axis moving assembly is connected to the first A-axis moving assembly, a second end of the B-axis moving assembly is connected to the second A-axis moving assembly, the B-axis moving assembly is connected to the X-axis moving assembly, and the B-axis moving assembly is configured to drive the first A-axis moving assembly and the second A-axis moving assembly to rotate, wherein
in an initial state, the X-axis moving assembly is configured to drive the B-axis moving assembly to move in an X-axis direction, the Y-axis moving assembly is configured to drive the Z-axis moving assembly to move in a Y-axis direction, the Z-axis moving assembly is configured to drive the cutting spindle to move in a Z-axis direction, and the first A-axis moving assembly and the second A-axis moving assembly are configured to rotate around the X-axis direction.

2. The dental engraving and milling machine according to claim 1, further comprising
a first protective enclosure, wherein a first accommodating space is provided in the first protective enclosure, the first protective enclosure is connected to the first A-axis moving assembly, and the first A-axis moving assembly is located in the first accommodating space; and
a second protective enclosure, wherein a second accommodating space is provided in the second protective enclosure, the second protective enclosure is connected to the second A-axis moving assembly, and the second A-axis moving assembly is located in the second accommodating space, wherein
a side that is of the first protective enclosure and that is close to the first end of the B-axis moving assembly is provided with a first slot, the first A-axis moving assembly passes through the first slot and is connected to the first end of the B-axis moving assembly, a side that is of the second protective enclosure and that is close to the second end of the B-axis moving assembly is provided with a second slot, and the second A-axis moving assembly passes through the second slot and is connected to the second end of the B-axis moving assembly.

3. The dental engraving and milling machine according to claim 2, further comprising
a dry cutting dust collector, wherein the dry cutting dust collector is connected to the housing, the dry cutting dust collector is located in the cavity, and the dry cutting dust collector is electrically connected to the controller, wherein
a first notch is provided on the first protective enclosure, the first protective enclosure is connected to the dry cutting dust collector at the first notch through first tubing, and the dry cutting dust collector is configured to adsorb dust generated during dental prosthesis processing.

4. The dental engraving and milling machine according to claim 2, further comprising
a cutting fluid circulation module, wherein the cutting fluid circulation module is connected to the housing, the cutting fluid circulation module is located in the cavity, and the cutting fluid circulation module is electrically connected to the controller, wherein
a second notch is provided on the second protective enclosure, the second protective enclosure is connected to the cutting fluid circulation module at the second notch through second tubing, the cutting fluid circulation module is configured to circulate a cutting fluid, a water pump is disposed on the Z-axis moving assembly, an input end of the water pump is connected to the cutting fluid circulation module, and an output end of the water pump is capable of spraying water toward the tool.

5. The dental engraving and milling machine according to claim 1, wherein
the first dental prosthesis fixture comprises an arched block, wherein the arched block is fixedly connected to a fixture clamping slot provided at the output end of the first A-axis moving assembly, an end that is of the arched block and that is away from the clamping slot is provided with a locating slot, and the locating slot is fixedly connected to the dental prosthesis blank.

6. The dental engraving and milling machine according to claim 1, further comprising a calibration jig and a photoelectric sensor, wherein the calibration jig comprises a calibration ring, the calibration ring is detachably mounted on the first dental prosthesis fixture, a measurement through hole is provided on a center position of the calibration ring, a bottom of the measurement through hole is fixedly connected to a calibration surface, and the photoelectric sensor is configured to perform zero-point calibration on a motion axis of the dental engraving and milling machine by detecting the calibration ring and the calibration surface.

7. The dental engraving and milling machine according to claim 1, wherein
the X-axis moving assembly comprises a first base plate and an X-axis servo motor, wherein the first base plate is connected to the X-axis servo motor, the X-axis servo motor is located on a first side of the first base plate, a temperature sensor is connected to the first base plate, the temperature sensor is located on a second side that is of the first base plate and that is away from the X-axis servo motor, actuating elements are further connected to the first base plate, and the actuating elements are respectively located on a third side and a fourth side of the first base plate;
the Y-axis moving assembly comprises a second base plate and a Y-axis servo motor, wherein the second base plate is connected to the Y-axis servo motor, a temperature sensor is connected to the second base plate, the temperature sensor is located on a side of the second base plate, an actuating element is also connected to the second base plate, and the actuating element is located on a surface that is of the second base plate and that is away from the Y-axis servo motor; and
the dental engraving and milling machine further comprises a frequency converter, wherein the frequency converter is located in the cavity, and the frequency converter is electrically connected to the controller.

8. A calibration method of the dental engraving and milling machine according to claim 1, comprising the following steps:
S1, obtaining an X-axis zero point of the X-axis moving assembly and a Y-axis zero point of the Y-axis moving assembly;
S2, determining a Z-axis zero point of the Z-axis moving assembly, an A-axis zero point of the first A-axis moving assembly and a B-axis zero point of the B-axis moving assembly according to the X-axis zero point and the Y-axis zero point; and
S3, obtaining a zero point of the motion axis of the dental engraving and milling machine according to the X-axis zero point, the Y-axis zero point, the A-axis zero point, and the B-axis zero point, to complete zero-point calibration of the motion axis of the dental engraving and milling machine.

9. The calibration method according to claim 8, wherein in the step S1, the obtaining an X-axis zero point comprises:
controlling the cutting spindle to move a sensing end head of the photoelectric sensor into the measurement through hole, and making the sensing end head of the photoelectric sensor be located above the calibration surface;
controlling the photoelectric sensor to move forward along an X-axis until an edge of the measurement through hole is detected by the sensing end head of the photoelectric sensor, stopping the X-axis, and recording a first X-axis measurement value x₁ when the photoelectric sensor moves forward along the X-axis;
controlling the photoelectric sensor to move reversely along the X-axis until the edge of the measurement through hole is detected by the sensing end head of the photoelectric sensor, stopping the X-axis, and recording a second X-axis measurement value x₂ when the photoelectric sensor moves reversely along the X-axis; and
obtaining a position parameter x₀ of the X-axis zero point according to the first X-axis measurement value x₁ and the second X-axis measurement value x₂, wherein
a calculation formula of the position parameter x₀ of the X-axis zero point is as follows:
$${x}_{0} = \frac{{x}_{1} + {x}_{2}}{2} ;$$
thereby obtaining coordinates (x₀, 0) of the X-axis zero point; and
the obtaining a Y-axis zero point comprises:
controlling the cutting spindle to move the sensing end head of the photoelectric sensor into the measurement through hole, and making the sensing end head of the photoelectric sensor be located above the calibration surface;
controlling the photoelectric sensor to move forward along a Y axis until the edge of the measurement through hole is detected by the sensing end head of the photoelectric sensor, stopping the Y-axis, recording a first Y-axis measurement value y₁ when the photoelectric sensor moves forward along the Y-axis;
controlling the photoelectric sensor to move reversely along the Y axis until the edge of the measurement through hole is detected by the sensing end head of the photoelectric sensor, stopping the Y-axis, and recording a second Y-axis measurement value y₂ when the photoelectric sensor moves reversely along the Y-axis; and
obtaining a position parameter y₀ of the Y-axis zero point according to the first Y-axis measurement value y₁ and the second Y-axis measurement value y₂, wherein
a calculation formula of the position parameter y₀ of the Y-axis zero point is as follows:
$${y}_{0} = \frac{{y}_{1} + {y}_{2}}{2} ;$$
thereby obtaining coordinates (0, y₀) of the Y-axis zero point.

10. The calibration method according to claim 8, wherein in the step S2, the obtaining a Z-axis zero point comprises:
determining origin coordinates (x₀, y₀) of a first plane according to the X-axis zero point and the Y-axis zero point; and
controlling the photoelectric sensor to be located at a coordinate origin position of the first plane, moving the photoelectric sensor along a Z-axis until a sensing end head of the photoelectric sensor is in contact with the calibration surface, stopping the Z-axis, and obtaining coordinates (x₀, y₀, z₀) of the Z-axis zero point, wherein a contact position is a position z₀ of the Z-axis zero point.

11. The calibration method according to claim 8, wherein in the step S2, the obtaining an A-axis zero point comprises:
determining origin coordinates (x₀, y₀) of a first plane according to the X-axis zero point and the Y-axis zero point;
controlling a sensing end head of the photoelectric sensor to be located at a coordinate origin position of the first plane;
after controlling the sensing end head of the photoelectric sensor to move for a first distance along a Z-axis in a direction away from the calibration jig, controlling the photoelectric sensor to move forward for a second distance along a Y-axis, to make the sensing end head of the photoelectric sensor be located on an upper surface of the calibration ring;
controlling the sensing end head of the photoelectric sensor to move along the Z-axis in a direction close to the calibration jig to make the sensing end head of the photoelectric sensor be in contact with the upper surface of the calibration ring, stopping the Z-axis, and recording a first A-axis measurement value A₁;
controlling the sensing end head of the photoelectric sensor to return to the coordinate origin position of the first plane;
after controlling the sensing end head of the photoelectric sensor to move for the first distance along the Z-axis in the direction away from the calibration jig, controlling the photoelectric sensor to move reversely for the second distance along the Y-axis, to make the sensing end head of the photoelectric sensor be located on the upper surface of the calibration ring;
controlling the sensing end head of the photoelectric sensor to move along the Z-axis in the direction close to the calibration jig to make the sensing end head of the photoelectric sensor be in contact with the upper surface of the calibration ring, stopping the Z-axis, and recording a second A-axis measurement value A₂; and
obtaining a position parameter A₀ of the A-axis zero point according to the first A-axis measurement value A₁ and the second A-axis measurement value A₂, wherein
a calculation formula of the position parameter A₀ of the A-axis zero point is as follows:
$${A}_{0} = \frac{{A}_{1} - {A}_{2}}{2} .$$

12. The calibration method according to claim 11, further comprising calibration of the A-axis zero point, wherein the calibration of the A-axis zero point comprises:
when A₀ is positive,
after controlling the sensing end head of the photoelectric sensor to return to the coordinate origin position of the first plane, controlling the sensing end head of the photoelectric sensor to move for the first distance along the Z-axis in the direction away from the calibration jig, and then controlling the photoelectric sensor to move forward for the second distance along the Y-axis, to make the sensing end head of the photoelectric sensor be located on the upper surface of the calibration ring; and
after controlling the sensing end head of the photoelectric sensor to move along the Z-axis for a distance of A₁−A₀ in the direction close to the calibration jig, stopping the Z-axis, controlling the calibration jig to rotate around an X-axis until the sensing end head of the photoelectric sensor is controlled to be in contact with the upper surface of the calibration ring, thereby completing the calibration of the A-axis zero point; or
when A₀ is negative,
after controlling the sensing end head of the photoelectric sensor to return to the coordinate origin position of the first plane, controlling the sensing end head of the photoelectric sensor to move for the first distance along the Z-axis in the direction away from the calibration jig, and then controlling the photoelectric sensor to move reversely for the second distance along the Y-axis, to make the sensing end head of the photoelectric sensor be located on the upper surface of the calibration ring; and
after controlling the sensing end head of the photoelectric sensor to move along the Z-axis for a distance of A₂−A₀ in the direction close to the calibration jig, stopping the Z-axis, controlling the calibration jig to rotate around an X-axis until the sensing end head of the photoelectric sensor is controlled to be in contact with the upper surface of the calibration ring, thereby completing the calibration of the A-axis zero point.

13. A control method of the dental engraving and milling machine according to claim 1, comprising the following steps:
performing initialization on the controller, and obtaining, by the controller, a temperature parameter, a first status code of the frequency converter, a second status code of a servo driver group, and status information of a numerical control (NC) task;
determining whether to perform a first protective action based on the temperature parameter;
determining whether to perform a second protective action based on the first status code;
determining whether to perform a third protective action based on the second status code; and
determining whether to perform a fourth protective action based on the status information of the NC task.

14. The control method according to claim 13, wherein the determining whether to perform a first protective action based on the temperature parameter comprises:
determining whether the temperature parameter is within a preset temperature range, and determining that a temperature is normal if the temperature parameter is within the preset temperature range; and
performing, by an actuating element, the first protective action if the temperature parameter is not within the preset temperature range, wherein
the preset temperature range is from 28° C. to 50° C.

15. The control method according to claim 13, wherein the determining whether to perform a second protective action based on the first status code comprises:
determining whether the first status code is zero, determining that a device status is abnormal if the first status code is zero, obtaining a first error code, sequentially analyzing correlations between the first error code and a voltage, a load current, as well as a short-circuit fault, obtaining a first abnormal element, and performing the second protective action based on the first abnormal element; and
determining that the device status is normal if the first status code is not zero.

16. The control method according to claim 13, wherein the determining whether to perform a third protective action based on the second status code comprises:
sequentially determining whether second status codes of all servo drivers in the servo driver group are zero, determining that the device status is abnormal if the second status code of any servo driver is zero, obtaining a second error code, sequentially analyzing correlations between the second error code and a voltage, a load current, as well as a short-circuit fault, obtaining a second abnormal element, and performing the third protective action based on the second abnormal element; and
determining that the device status is normal if the second status codes of all servo drivers are not zero.

17. The control method according to claim 13, wherein the determining whether to perform a fourth protective action based on the status information of the NC task comprises:
sequentially analyzing correlations between the status information of the NC task and startup, pause, completion, as well as exception interrupt to obtain a status text of the NC task;
obtaining a protective instruction based on the status text; and
performing the fourth protective action based on the protective instruction.

18. The control method according to claim 13, further comprising
performing initialization on a device, creating, by the controller, an instruction file, and receiving, by the device, the instruction file;
selecting, by the device, a working mode based on the instruction file, wherein the working mode comprises a dry-cutting mode and a wet-cutting mode; and
processing, by the first A-axis moving assembly that cooperates with the cutting spindle, a dental prosthesis blank if the working mode is the dry-cutting mode; or
processing, by the second A-axis moving assembly that cooperates with the cutting spindle, a dental prosthesis blank if the working mode is the wet-cutting mode.

19. The control method according to claim 18, wherein the creating, by the controller, an instruction file comprises:
selecting a serial number of the dental engraving and milling machine and a fixture;
selecting a dental bank based on a material characteristic and a scaling ratio;
determining three-dimensional data of a to-be-required dental prosthesis based on a requirement of the to-be-required dental prosthesis;
determining the working mode based on the dental prosthesis blank;
determining a selection instruction of the protective enclosure, a water pump working instruction and a dust collection working instruction based on the working mode; and
determining a rotation speed of the cutting spindle based on the three-dimensional data of the to-be-required dental prosthesis.

20. The control method according to claim 19, wherein the processing, by the first A-axis moving assembly that cooperates with the cutting spindle, a dental prosthesis blank if the working mode is the dry-cutting mode comprises:
setting a first movement range of the output end of the Y-axis moving assembly;
controlling the cutting spindle to rotate based on the rotation speed of the cutting spindle;
controlling on and off of the dry cutting dust collector based on the dust collection working instruction;
adjusting an operation power of the dry cutting dust collector according to machining allowance; and
processing the dental prosthesis blank based on the three-dimensional data of the to-be-required dental prosthesis.

21. The control method according to claim 20, wherein the adjusting an operation power of the dry cutting dust collector according to machining allowance comprises:
setting the dry cutting dust collector to operate at a first power if the machining allowance is first machining allowance;
setting the dry cutting dust collector to operate at a second power if the machining allowance is second machining allowance; and
setting the dry cutting dust collector to operate at a third power if the machining allowance is third machining allowance, wherein
the first power is greater than the second power that is greater than the third power, and the first machining allowance is greater than the second machining allowance that is greater than the third machining allowance.

22. The control method according to claim 19, wherein the processing, by the second A-axis moving assembly that cooperates with the cutting spindle, a dental prosthesis blank if the working mode is the wet-cutting mode comprises:
setting a second movement range of the output end of the Y-axis moving assembly;
controlling the cutting spindle to rotate based on the rotation speed of the cutting spindle;
controlling on and off of the water pump based on the water pump working instruction; and
processing the dental prosthesis blank based on the three-dimensional data of the to-be-required dental prosthesis.
